(19) United States
(12) Patent Application Publication
(10) Pub. No.: US 2026/0186861 A1
(43) Pub. Date: Jul. 2, 2026

(54) TARGET SYSTEM OPTIMIZATION WITHIN A DISTRIBUTED ENVIRONMENT

(71) Applicant: Assurant, Inc., New York, NY (US)

(72) Inventors: Thomas Lynn, Powder Springs, GA (US); Harsh Patel, Atlanta, GA (US); Lolite Lawrence, Kingston (CA); Russell Weitz, Charlotte, NC (US); Chad Blessinger, Spring, TX (US); Ty Viger, The Woodlands, TX (US)

(21) Appl. No.: 19/412,119

(22) Filed: Dec. 8, 2025

Related U.S. Application Data
(60) Provisional application No. 63/740,643, filed on Dec. 31, 2024.

(51) Int. Cl. G06F 9/50; G06F 11/34

(52) U.S. Cl. CPC G06F 9/5083; G06F 11/3409

(57) ABSTRACT

An example system, a computer-implemented method, and a computer program product for triggering a rebalance of a target entity are provided. The example system includes a set of subject entity systems and a target entity system. Each subject entity system includes a plurality of constituent data entities and is associated with subject entity performance metrics. The target entity system includes an initial set of constituent data entities and is associated with target entity performance metrics. The system includes a processor configured to execute a target entity optimization model framework, including at least aggregating subject entity performance metrics to generate a dynamic aggregated performance metric set, programmatically generating an offset index for the target entity system based on a comparison with the dynamic aggregated performance metric set, and based on the offset index, triggering a balancing of the initial target constituent data entity set.

### CROSS-REFERENCE TO RELATED APPLICATIONS

This application claims the benefit of U.S. Provisional Patent Application No. 63/740,643, entitled “TARGET SYSTEM OPTIMIZATION WITHIN A DISTRIBUTED ENVIRONMENT,” which was filed Dec. 31, 2024, the entirety of which is hereby incorporated by reference.

### FIELD OF THE INVENTION

Embodiments of the present disclosure relate generally to target system optimization.

### BACKGROUND

In distributed system of discrete entities, a new or otherwise unoptimized entity may lack one or more constituent components or lack properly optimized constituent components. Such new or otherwise unoptimized entities may require extensive experimentation and tuning over many operational cycles (e.g., weeks, months, or years) before finally arriving at an optimized solution. Moreover, analyzing and improving the performance of a target entity, in the presence of multiple interrelated variables may prove difficult or impossible. Applicant has identified many technical challenges and difficulties associated with analyzing the performance and providing improvements to a target entity and subsequent challenges to reconfiguring the target entity to optimize performance. Through applied effort, ingenuity, and innovation, Applicant has solved problems related to analyzing and improving a target entity by developing solutions embodied in the present disclosure, which are described in detail below.

### BRIEF SUMMARY

Various embodiments are directed to an example system, computer-implemented method, and computer program product for triggering a rebalance of a target entity.

An example system is provided. The example system comprises a set of subject entity systems and a target entity system. Each subject entity system of the set of subject entity systems comprises a subject entity constituent data entity set comprising a subject entity subset of a plurality of constituent data entities, and one or more subject entity performance metrics associated with the subject entity. The target entity system comprises an initial target constituent data entity set comprising a target entity subset of the plurality of constituent data entities, and one or more target entity performance metrics associated with the target entity. In addition, the system comprises at least one non-transitory computer readable medium comprising computer program instructions that, when executed by at least one processor, are configured to execute a target entity optimization model framework by: aggregating the one or more subject entity performance metrics associated with a subset of the set of subject entity systems to generate a dynamic aggregated performance metric set; retrieving the one or more target entity performance metrics associated with the target entity; programmatically generating an offset index for the target entity system based on a comparison of the dynamic aggregated performance metric set and the one or more target entity performance metrics associated with the target entity; and based on the offset index, triggering a balancing of the initial target constituent data entity set associated with the target entity system to generate an updated target constituent data entity set, the balancing comprising improving the target entity system by augmenting at least one constituent data entity of the target entity subset of the plurality of constituent data entities or adding at least one additional constituent data entity of the plurality of constituent data entities to the target entity subset of the plurality of constituent data entities.

In some embodiments, aggregating the one or more subject entity performance metrics comprises selecting the subset of the set of subject entity systems based on geolocation data associated with the subset of subject entities.

In some embodiments, the geolocation data comprises location data values associated with the set of subject entity systems and a target location data value associated with the target entity. In such an embodiment, the computer program instructions, when executed by the at least one processor, are further configured to: compare distances between the location data values associated with at least the subset of the set of subject entity systems and the target location data value associated with the target entity with a maximum threshold distance; and select the subset of the set of subject data entity systems based on determining that the distances are less than the maximum threshold distance.

In some embodiments, the geolocation data comprises a geolocation characteristic associated with the set of subject entity systems and a target geolocation characteristic associated with the target entity. In such an embodiment, the computer program instructions, when executed by the at least one processor, are further configured to: compare the geolocation characteristic associated with at least the subset of the set of subject data entity systems and the target geolocation characteristic associated with the target entity with a geolocation characteristic range; and select the subset of the set of subject entity systems based on determining that the geolocation characteristics are within the geolocation characteristic range.

In some embodiments, in aggregating the one or more subject entity performance metrics, the computer program instructions, when executed by the at least one processor, are further configured to: compare a difference in a size of the subject entity constituent data entity set associated with at least the subset of the set of subject entity systems and a size of the initial target constituent data entity set associated with a maximum difference threshold; and select the subset of the set of subject data entity systems based on determining that the difference is less than a the maximum difference threshold.

In some embodiments, in aggregating the one or more subject entity performance metrics, the computer program instructions, when executed by the at least one processor, are further configured to: select one or more reference constituent data entities in the initial target constituent data entity set; and select a subject data entity for inclusion in the subset of the set of subject data entity systems based on determining that the subject data entity comprises the one or more reference constituent data entities in the subject entity constituent data entity set.

In some embodiments, in generating the dynamic aggregated performance metric set, the computer program instructions, when executed by the at least one processor, are further configured to: receive one or more updated performance metrics via user inputs to a graphical user interface; determine a second subset of the set of subject entity systems based on the updated performance metrics; aggregate the one or more subject entity performance metrics associated with the second subset of the set of subject entity systems to update the dynamic aggregated performance metric set; and programmatically generate an updated offset index for the target entity system based on a comparison of the dynamic aggregated performance metric set and the one or more target entity performance metrics associated with the target entity.

In some embodiments, in an instance in which the one or more target entity performance metrics are updated via user inputs to a graphical user interface, the computer program instructions, when executed by the at least one processor, are further configured to: programmatically regenerate the offset index based on a comparison of the dynamic aggregated performance metric set and the one or more target entity performance metrics associated with the target entity.

In some embodiments, the computer program instructions, when executed by the at least one processor, are further configured to: generate updated subject entity performance metrics based on the updated target constituent data entity set; compare the updated subject entity performance metrics with the one or more subject entity performance metrics associated with the initial target constituent data entity set; and confirm the updated subject entity performance metrics represent an improvement over the one or more subject entity performance metrics associated with the initial target constituent data entity set.

An example computer-implemented method is further provided. In some embodiments, the example computer-implemented method comprises: determining, by a target entity optimization model framework, a subset of a set of subject entity systems, each subject entity system comprising: a subject entity constituent data entity set comprising a subject entity subset of a plurality of constituent data entities; and one or more subject entity performance metrics associated with the subject entity. The computer-implemented method further comprises: aggregating the one or more subject entity performance metrics associated with the subset of the set of subject entity systems to generate a dynamic aggregated performance metric set; and retrieving from a target entity system one or more target entity performance metrics associated with a target entity, the target entity system comprising: an initial target constituent data entity set comprising a target entity subset of the plurality of constituent data entities; and the one or more target entity performance metrics associated with the target entity. The computer-implemented method further comprising programmatically generating an offset index for the target entity system based on a comparison of the dynamic aggregated performance metric set and the one or more target entity performance metrics associated with the target entity; and based on the offset index, triggering a balancing of the initial target constituent data entity set associated with the target entity system to generate an updated target constituent data entity set, the balancing comprising improving the target entity system by augmenting at least one constituent data entity of the target entity subset of the plurality of constituent data entities or adding at least one additional constituent data entity of the plurality of constituent data entities to the target entity subset of the plurality of constituent data entities.

In some embodiments, aggregating the one or more subject entity performance metrics comprises selecting the subset of the set of subject entity systems based on geolocation data associated with the subset of the set of subject entity systems.

In some embodiments, the geolocation data comprises location data values associated with the set of subject entities and a target location data value associated with the target entity. In such an embodiment the computer-implemented method may further comprise: comparing distances between the location data values associated with at least the subset of the set of subject data entities and the target location data value associated with the target entity with a maximum threshold distance; and selecting the subset of the set of subject entity systems based on determining that the distances are less than the maximum threshold distance.

In some embodiments, the geolocation data comprises a geolocation characteristic associated with the set of subject entities and a target geolocation characteristic associated with the target entity. In such an embodiment, the computer-implemented method may further comprise comparing the geolocation characteristic associated with at least the subset of the set of subject entity systems and the target geolocation characteristic associated with the target entity with a geolocation characteristic range; and selecting the subset of the set of subject entity systems based on determining that the geolocation characteristics are within the geolocation characteristic range.

In some embodiments, in aggregating the one or more subject entity performance metrics, the computer-implemented method further comprises: comparing a difference in a size of the subject entity constituent data entity set associated with at least the subset of the set of subject entity systems and a size of the initial target constituent data entity set associated with a maximum difference threshold; and selecting the subset of the set of subject entity systems based on determining that the difference is less than a the maximum difference threshold.

In some embodiments, in aggregating the one or more subject entity performance metrics, the computer-implemented method further comprises: selecting one or more reference constituent data entities in the initial target constituent data entity set; and selecting a subject data entity for inclusion in the subset of the set of subject entity systems based on determining that the subject data entity comprises the one or more reference constituent data entities in the subject entity constituent data entity set.

In some embodiments, in generating the dynamic aggregated performance metric set, the computer-implemented method further comprises: updating the dynamic aggregated performance metric set with a second plurality of performance metrics associated with a second subset of the set of subject entity systems; and programmatically regenerating the offset index based on a comparison of the dynamic aggregated performance metric set and the one or more target entity performance metrics associated with the target entity.

In some embodiments, in generating the dynamic aggregated performance metric set, the computer-implemented method further comprises: receiving one or more updated performance metrics via user inputs to a graphical user interface; determining the second subset of the set of subject entity systems based on the updated performance metrics; aggregating the one or more subject entity performance metrics associated with the second subset of the set of subject entity systems to update the dynamic aggregated performance metric set; and programmatically generating an updated offset index for the target entity system based on a comparison of the dynamic aggregated performance metric set and the one or more target entity performance metrics associated with the target entity.

In some embodiments, in an instance in which the one or more target entity performance metrics are updated via user inputs to a graphical user interface, the computer-implemented method further comprises: programmatically regenerating the offset index based on a comparison of the dynamic aggregated performance metric set and the one or more target entity performance metrics associated with the target entity.

In some embodiments, the computer-implemented method further comprises: generating updated subject entity performance metrics based on the updated target constituent data entity set; comparing the updated subject entity performance metrics with the one or more subject entity performance metrics associated with the initial target constituent data entity set; and confirming the updated subject entity performance metrics represent an improvement over the one or more subject entity performance metrics associated with the initial target constituent data entity set.

An example computer program product is also provided. In some embodiments, the example computer program product is stored on at least one computer readable medium, comprising instructions that when executed by one or more computers cause the one or more computers to: determine, by a target entity optimization model framework, a subset of a set of subject entity systems. Each subject entity system comprises a subject entity a subject entity constituent data entity set comprising a subject entity subset of a plurality of constituent data entities; and one or more subject entity performance metrics associated with the subject entity. The instructions when executed by the one or more computers further cause the one or more computers to: aggregate the one or more subject entity performance metrics associated with the subset of the set of subject entity systems to generate a dynamic aggregated performance metric set; and retrieve from a target entity system one or more target entity performance metrics associated with a target entity. The target entity system comprising an initial target constituent data entity set comprising a target entity subset of the plurality of constituent data entities; and the one or more target entity performance metrics associated with the target entity. The instructions when executed by the one or more computers further cause the one or more computers to: programmatically generate an offset index for the target entity system based on a comparison of the dynamic aggregated performance metric set and the one or more target entity performance metrics associated with the target entity; and based on the offset index, trigger a balancing of the initial target constituent data entity set associated with the target entity system to generate an updated target constituent data entity set, the balancing comprising improving the target entity system by augmenting at least one constituent data entity of the target entity subset of the plurality of constituent data entities or adding at least one additional constituent data entity of the plurality of constituent data entities to the target entity subset of the plurality of constituent data entities.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an example target entity optimization system in accordance with an example embodiment of the present disclosure.

FIG. 2 illustrates a block diagram of an example subject entity in accordance with an example embodiment of the present disclosure.

FIG. 3 illustrates a block diagram of an example target entity in accordance with an example embodiment of the present disclosure.

FIG. 4 illustrates a block diagram of an example target entity optimization model framework in accordance with an example embodiment of the present disclosure.

FIG. 5 provides an example flow chart depicting a process for triggering a balancing of a target constituent data entity set in accordance with an example embodiment of the present disclosure.

FIG. 6 illustrates an example target entity optimization user interface for adjusting one or more parameters related to a target entity optimization model framework in accordance with an example embodiment of the present disclosure.

FIG. 7 illustrates an example graphical user interface for viewing one or more parameters related to a target entity optimization model framework in accordance with an example embodiment of the present disclosure.

FIG. 8 illustrates an example graphical user interface for viewing visual representations of an offset index as determined by a target entity optimization model framework in accordance with an example embodiment of the present disclosure.

FIG. 9 illustrates an example target entity forecast display interface in accordance with an example embodiment of the present disclosure.

FIG. 10 illustrates an example graphical user interface for viewing visual representations of performance metrics of a target entity in accordance with an example embodiment of the present disclosure.

FIG. 11 depicts an example block diagram of compute components of a target entity in accordance with an example embodiment of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. While values for dimensions of various elements may be disclosed, the drawings may not be to scale.

The words “example,” or “exemplary,” when used herein, are intended to mean “serving as an example, instance, or illustration.” Any implementation described herein as an “example”, or “exemplary embodiment” is not necessarily preferred or advantageous over other implementations.

### Overview

Embodiments of the present disclosure relate to analyzing and modifying one or more target entity systems using a central constituent entity control system to identify offsets in the performance of a target entity system and balancing or rebalancing the constituent components of the target entity system to optimize the system's performance. Various example embodiments address technical problems associated with providing dynamic and flexible analysis of a target entity and a target constituent data entity set associated with the target entity based on a comparison with one or more dynamically selected subject entities while using a unique framework to dynamically gather, maintain, aggregate, and deploy constituent entity data sets and entity performance metrics. Based on these dynamic and flexible analyses and the systems and processes that may facilitate them, various embodiments of the present disclosure may further address technical problems associated with generating and deploying rapid (e.g., real time or near real time) balancing of a target entity for optimal performance.

There are numerous example scenarios in which a target entity may be improved by balancing an associated target constituent data entity set based on data derived from dynamically selected subject entities. For example, a target entity may include a target constituent data entity set comprising constituent data entities associated with one or more supplemental offerings of the target entity. The target entity may further include target entity performance metrics representing the performance of a target entity. In some instances, the system may be configured to improve the performance of the target entity using the analysis and balancing systems and frameworks described herein. For example, one or more metrics may be identified and manipulated for optimization of the target entity, such as automatically using the processes described herein and/or via an adjustable graphical user interface. The system may then be configured to balance the target constituent data entity set (e.g., via adding or removing constituent data entities or modifying existing constituent data entities) variations in the target constituent data entity set associated with the target entity to improve performance. In such an example, the variations in the target constituent data entity set may need to be flexible and dynamic based on the specific target entity and feedback from the user.

Example embodiments of the present disclosure may include a central constituent entity control system utilizing a target entity optimization model framework configured to facilitate analysis, customization, and improvement performance of a target entity rapidly based on various data sources without requiring experimentation or other direct manipulation or testing of the target entity or target entity constituent data entities prior to balancing. The target entity optimization model framework may access various preexisting data related to the target entity, such as target entity characteristics, the target constituent data entity set, the target entity performance metrics. In some embodiments, the target entity data may be accessed automatically through a database, server, or other accessible storage system. In some embodiments, the target entity data may be input by a user through a graphical user interface. The target entity optimization model framework of the central constituent entity control system may generate a target entity forecast based on the accessible target entity data, constituent data entity metrics from a constituent data entity metrics set, and/or aggregated data from one or more subject entities (e.g., dynamic aggregated performance metric set). The target entity forecast may optionally include forecast performance metrics based on aggregated data associated with a target entity over a period of time. In some embodiments, a user may dynamically update the target entity forecast by altering the target entity performance metrics generated by the target entity optimization model framework and/or by altering the target entity data associated with the target entity. Such flexibility enables a user to compare a target entity to subject entities and generate customized configurations to balance the target entity and target entity constituent data entities based on certain variations available to the target entity. Further, a user may identify priorities to the central constituent entity control system, for example, optimization of a particular performance metric may be indicated. In some embodiments, the target entity optimization model framework may apply rule-based or machine learning benchmarks to the target entity forecast values to alter the generated target entity forecast.

In some embodiments, the target entity optimization model framework of the central constituent entity control system may access various data related to one or more subject entities and/or other data associated with one or more constituent data entities. The subject entities may be spaced from and operated at least partly independently of the target entity. Data may be accessed via databases associated with the subject entities, an aggregated subject entity database, and/or a constituent data entity metrics set. For example, a target entity optimization model framework may access subject entity characteristics, subject entity performance metrics, subject entity constituent data entity sets, and other data generated by or related to the subject entities or constituent data entities of the subject entities. The target entity optimization model framework of the central constituent entity control system may select a subset of subject entities based on subject entity characteristics, constituent data entities within subject entity constituent data entity sets, or another trait of the subject entities. For example, a subject entity may be selected for inclusion in a subset of subject entities based on a common location characteristic and/or based on a subject entity size characteristic. Based on the subset of subject entities, the target entity optimization model framework may generate a dynamic aggregated performance metric set. The dynamic aggregated performance metric set may include subject entity performance metrics, as well as subject entity characteristics, and/or subject entity constituent data entity sets of the subject entities included in the subset of subject entities. In addition, the target entity optimization model framework may generate a subject entity forecast based on the subset of subject entities included in the dynamic aggregated performance metric set.

In some embodiments, the target entity optimization model framework may include a forecast offset adjustment model configured to compare the subject entity forecast with the target entity forecast and determine an offset index based on the comparison. The offset index may indicate differences between the target entity forecast and the subject entity forecast, for example, differences in performance metrics and differences in the target entity constituent data entity set and the constituent data entity sets associated with the subset of subject entities. The offset index may be utilized by the target entity optimization model framework to determine a recommended constituent data entity set and/or balanced constituent data entity set, including additional constituent data entities, removal of constituent data entities, and/or modifications of one or more parameters of constituent data entities based on the current target entity constituent data entity set. The framework may additionally or alternatively provide benchmarking and visualization of target entity performance (actuals and/or forecast) along with one or more interfaces to facilitate on-the-fly adjustment of the inputs and goals of the framework to both increase the explainability of the recommendation constituent data entity set and the customizability of the recommendation constituent data entity set. The adjustments may facilitate real time visualization of predicted performance for the target entity prior to implementation of the recommended constituent data entity set and may facilitate rapid adjustment and balancing of the target entity system upon execution of the recommended constituent data entity set.

Moreover, the subject data entities, the constituent data entity metrics set, and other data sources described herein may regularly (e.g., continuously, periodically at predetermined intervals, or upon other triggers) report or be triggered to report updated data sets, and the target entity optimization model framework may be configured to update the individual aggregated data sets described herein to facilitate accurate customization of the target entity system in real time, near real time, or other rapid turnaround, which may also at least in part facilitate the real time interface adjustability described herein thus further improving the customizability of the target entity system.

As a result of the herein described example embodiments, changes to a target entity constituent data entity set based on an offset index may result in improvements to the performance in the operation of a target entity (e.g., net output, efficiency, etc.). In addition, flexibility in generating subject entity forecasts and target entity forecasts based on dynamic user input may result in an offset index tailored based on the unique characteristics associated with a target entity.

### Definitions

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” refers to a physical storage medium (e.g., volatile, or non-volatile memory device), and may be differentiated from a “computer-readable transmission medium,” which refers to an electromagnetic signal.

As used herein, the terms “data structure,” “data object,” or “data set” refer interchangeably to data capable of being transmitted, received, and/or stored.

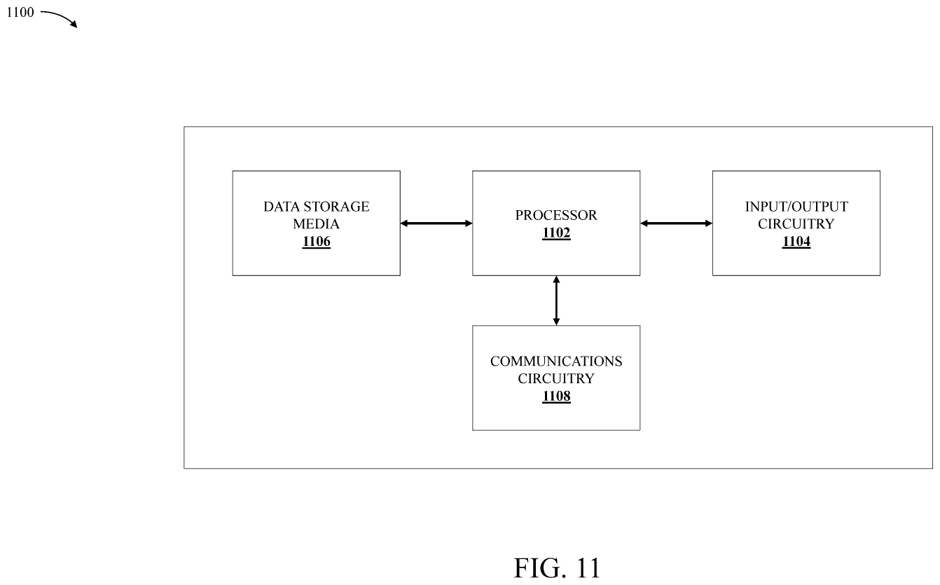

As used herein, a “target entity,” comprises any unit, object, entity, or combination of units, objects, and entities, associated with one or more target entity characteristics and including a target constituent data entity set. A target entity is subject to analysis and optimization, in coordination with a target entity optimization and model framework. The performance of a target entity may be evaluated based on one or more target entity performance metrics. In some embodiments, a target entity may comprise or otherwise be associated with a “target entity system”, which may comprise a system of one or more computing apparatuses (e.g., apparatus 1100 illustrated in FIG. 11) configured to facilitate various functionalities of the target entity described herein. The target entity system may include a plurality of interconnected computational units, for example servers. In some embodiments, a target entity may be associated with a business unit, establishment, enterprise, dealer, or similar body. In one non-limiting example, a data entity may be associated with an automobile dealership for which suggested product offerings may be provided.

Various aspects of a target entity may be updated or altered to increase the performance of a target entity. For example, the constituent data entities comprising an associated target constituent data entity set may be balanced. Balancing may include adding to the target constituent data entity set, removing from the target constituent data entity set, and/or augmenting at least one constituent data entity comprising the target constituent data entity set (e.g., modifying a feature or attribute of at least one constituent data entity). In some embodiments, balancing of the target constituent data entity set may occur in response to an offset index representing a comparison of the one or more target entity performance metrics and a dynamic aggregated performance metric set comprising data entity performance metrics associated with one or more subject entities.

As used herein, a “subject entity,” comprises any unit, object, entity, or combination of units, objects, and entities, associated with one or more subject entity characteristics and including a subject entity constituent data entity set. Certain subject entity characteristics and information associated with the subject entity constituent data entity set, and the constituent data entities included in the subject entity constituent data entity set may be available to a target entity optimization model framework. The subject entity performance metrics are further accessible to a target entity optimization model framework. In some embodiments, entity characteristics and information related to a subject entity may be stored on one or more databases accessible to a target entity optimization model framework connected to a network.

In some embodiments, a subject entity may comprise or otherwise be associated with a “subject entity system”, which may comprise a system of one or more computing apparatuses (e.g., apparatus 1100 illustrated in FIG. 11) configured to facilitate various functionalities of the subject entity described herein. The subject entity system may include a plurality of interconnected computational units, for example servers.

In some embodiments, a subject entity may be associated with a business unit, establishment, enterprise, dealer, or similar body for which entity characteristics and information may be recorded and/or tracked. In one non-limiting example, a subject entity may be associated with an automobile dealership for which suggested product offerings may be provided.

As used herein, “entity characteristics,” refer to any set of features, traits, attributes, demographics, or any other data identifying a data entity as belonging to an individual or group. Entity characteristics may be used to classify target and subject entities into particular groups, or sub-groups. For example, subject entities with a common entity characteristic or set of entity characteristics may be aggregated into a group, or sub-group, such as a subset of subject entities.

Entity characteristics may include characteristics related to size, location, type, structure, and other characteristics of a particular entity. Further entity characteristics, one or more of which may be utilized for grouping, may include a franchise affiliation associated with a particular data entity, a performance grouping associated with a particular data entity (e.g., quartile grouping), operational structure, product offerings, and constituent data entities associated with a data entity.

In some embodiments, at least a portion of a size parameter (e.g., historical sales totals, square footage, maximum inventory space, number of employees, etc.) may be included in the entity characteristics associated with a particular entity. A size parameter may relate to any characteristic of a target or subject entity related to size or quantity. Size parameters may include sizes related to data capacity, such as quantity of data, storage space, number of servers, etc. Size parameters may also relate to area of a target or subject entity, for example, square footage, lot size, number of stores, etc. Size parameters may further relate to inventory, for example, number of product offerings, size of constituent data entity set, quantity of one or more products, and so on. Size parameters may further relate to business revenue, for example, income, revenue, sales, purchases, net worth, total assets, debts. In some embodiments, size may further relate to number of employees, contractors, staff, full time positions, and so on.

A location parameter may relate to any characteristic of a target or subject entity related to a location, or proximity to a location or object. Location parameters may include geolocation of a target or subject entity, relative distance from another location parameter or geolocation, etc. Location parameters may also relate to the characteristics and/or demographics of an area surrounding a target or subject entity. For example, average income in an area, race statistics of an area, age statistics of an are, proximity to a major hub or population center, accessibility of a location, and so on.

In one non-limiting example, a target or subject entity may represent an automobile dealership. In such an example, entity characteristics may include average number of automobiles in inventory, average automobile sales, number of automobile trade-ins, average new automobile sales, average used automobile sales, average leases, average income, average revenue, and so on. Further entity characteristics may include characteristics related to the constituent data entity associated with the target or subject entity, for example, number of insurance package offerings, number of warranty offerings, penetration rates, and so on.

As used herein, “target entity characteristics,” refer to any set of features, traits, attributes, demographics, or any other data identifying a target entity as belonging to an individual or group. Target entity characteristics may be input, queried, and/or stored in association with a target entity and may be accessible to a target entity optimization model framework. Target entity characteristics may be utilized to associate a target entity with a subject entity having one or more common or similar characteristics.

As used herein, “subject entity characteristics,” refer to any set of features, traits, attributes, demographics, or any other data identifying a subject entity as belonging to an individual or group. Subject entity characteristics may be input, queried, and/or stored in association with a subject entity and may be accessible to a target entity optimization model framework. Subject entity characteristics for a variety of subject entities may be stored in a database and accessible through a network connection by a target entity optimization model framework. Subject entity characteristics may be utilized to associate a target entity with a set of one or more subject entities having one or more common or similar characteristics.

As used herein, a “constituent data entity,” refers to any component or other adjustable or configurable unit associated with an entity. Constituent data entities may include one or more parameters associated therewith that may be programmatically adjustable. Example constituent data entities may include commodity, object, data, product, offering, or other service provided by a target or subject entity to an external consumer. In some embodiments, a constituent data entity may represent a supplemental offering, such as an insurance offering, warranty offering, secondary offering, accessory offering, package of products, or other offering in addition to a primary offering or product provided by an associated target or subject entity. A constituent data entity may comprise a number of variable parameters, for example, a cost, a duration, a quantity, a scope, and so on. In a non-limiting example, a constituent data entity may be associated with add-on packages to an automobile purchase. Add-on packages may include insurance packages (e.g., vehicle service contracts, gap insurance), bundle options (e.g., combination of packages), financing contracts, accessory add-ons, service add-ons, credits, coupons, etc. Each add-on package may comprise a number of variables to the offering related to the cost, duration, quantity, scope, etc.

In some embodiments, a constituent data entity may be balanced by augmenting the constituent data entity in accordance with the various systems and processes described herein. In some examples, each of the variables to the offering may be adjusted. For example, a cost associated with a constituent data entity may be raised or lowered. In addition, variables such as a deductible, scope, duration, expense, or quantity of a constituent data entity may be altered. Augmentation may include altering or adjusting one or more one or more of the variables associated with a constituent data entity. The augmentation of a constituent data entity may be informed by an offset index generated by a target entity optimization model framework associated with a target entity. A target or subject entity may be associated with a plurality of constituent data entities in a constituent data entity set.

As used herein, a “target constituent data entity,” refers to any constituent data entity associated with a target entity and/or provided by a target entity to an external consumer, for example, in conjunction with a primary offering provided by the target entity. A target constituent data entity may comprise a number of variable parameters, for example, a cost, a duration, a quantity, a scope, and so on, that may be augmented in conjunction with a target entity optimization model framework.

In a non-limiting example, a constituent data entity may be associated with supplemental add-on packages to a primary automobile purchase. Add-on packages may include insurance packages (e.g., vehicle service contracts, gap insurance), bundle options (e.g., combination of packages), financing contracts, accessory add-ons, service add-ons, credits, coupons, etc. Each add-on package may comprise a number of variables to the offering related to the cost, duration, quantity, scope, etc.

In some examples, a target entity may be associated with a plurality of target constituent data entities in a target constituent data entity set.

As used herein, a “subject constituent data entity,” refers to any constituent data entity associated with a subject entity and/or provided by a subject entity to an external consumer, for example, in conjunction with a primary offering provided by the subject entity. A subject constituent data entity may comprise a number of variable parameters, for example, a cost, a duration, a quantity, a scope, and so on, that may be accessed by a subject entity optimization model framework in determining an offset index for a subject entity.

In a non-limiting example, a constituent data entity may be associated with supplemental add-on packages to a primary automobile purchase. Add-on packages may include insurance packages (e.g., vehicle service contracts, gap insurance), bundle options (e.g., combination of packages), financing contracts, accessory add-ons, service add-ons, credits, coupons, etc. Each add-on package may comprise a number of variables to the offering related to the cost, duration, quantity, scope, etc.

In some examples, a subject entity may be associated with a plurality of subject constituent data entities comprising a subject entity constituent data entity set.

As used herein, “constituent data entity metrics set” refers to any statistical data, information (whether raw or pre-processed), or other data representing the constituent data entity characteristics and/or performance metrics associated with one or more constituent data entities. The constituent data entity metrics set may include correlations between one or more constituent data entities and one or more particular performance metrics. In some embodiments, the constituent data entity metrics may correspond with a particular subject entity. In some embodiments, the constituent data entity metrics set may include aggregated statistics related to one or more constituent data entities, such as averages, medians, distributions, down-sampled representations, and other statistical representations of captured constituent data entity metrics.

In some embodiments, a plurality of constituent data entities may be bundled and distributed as a bundle of constituent data entities. The constituent data entity metrics set may further include statistical information related to bundled constituent data entities.

The constituent data entity metrics set may comprise a repository of data from various sources. For example, the constituent data entity metrics set may include local and/or on premises repositories from various data entities (e.g., subject entity, target entity, etc.). The constituent data entity metrics set may further include one or more network connected or cloud-based repositories, wherein one or more data entities may be configured to upload data related to constituent data entities. Further, the constituent data entity metrics set may comprise data local to the target entity, for example, a user may select local data to be included in the constituent data entity metrics set. In some embodiments, the constituent data entity may include or may be used to generate one or more semantic models.

As used herein, “entity performance metrics,” refer to any statistical data, information (whether raw or pre-processed), or other data representing the performance, whether actual or forecast, of a constituent data entity and/or a target or subject entity. Performance metrics may represent performance of a target or subject entity related to speed, finances, power consumption, accuracy, penetration, per-unit performance, and so on. In some embodiments, performance metrics associated with an individual constituent data entity (e.g., associated with a subject entity) may be specified as “constituent data entity performance metrics”, performance metrics associated with an entity as a whole may be specified as “entity performance metrics”, and subsets of the entity performance metrics associated with various categories may be specified as “global category performance metrics”.

In some examples, entity performance metrics related to finances may include income, income per time period, income per product sold, income per transaction, fee revenue, reserve per transaction, number of products sold, number of constituent data entities sold, saturation rate, penetration rate, and so on. In one embodiment, saturation rate may relate to the number of consumers in a particular subset associated with a subject entity. In one embodiment, penetration rate may relate to the number of primary product offerings for which one or more constituent data entities is provided.

In one non-limiting example, a subject and/or target entity may represent an automobile dealership. In such an example, entity performance metrics may represent total income of the dealership, income per vehicle, add-on packages per vehicle sold, reserve income per transaction, and so on.

As used herein, “target entity performance metrics,” refer to any entity performance metrics associated with a target entity. Target entity performance metrics may be input manually, estimated, automatically calculated based on models, read from a database, or by any combination thereof. In some embodiments, the target entity performance metrics may be calculated based on available data. For example, a target entity optimization model framework may receive and/or access target entity performance metrics associated with a target entity and generate a forecast model of the target entity performance metrics based on industry data, one or more subject entities, target entity plans/goals, and so on.

As used herein, “subject entity performance metrics,” refer to any entity performance metrics associated with a subject entity. Subject entity performance metrics may be input manually, estimated, automatically calculated based on models, read from a database, or by any combination thereof.

In some embodiments, the subject entity performance metrics of a set of subject entities may be accessible to a target entity optimization model framework. The subject entity performance metrics associated with the set of subject entities may be accessed and/or aggregated by the target entity optimization model framework to generate a dynamic aggregated performance metric set.

As used herein, “dynamic aggregated performance metric set” may comprise a collection or other aggregated set of subject entity performance metrics, subject entity characteristics, and/or information related to constituent data entity sets for one or more subject entities of a subset of subject entities. The dynamic aggregated performance metric set may be generated from data derived from one or more subject entity systems, data derived from the constituent data entity metrics set, the target entity system, and other data sources accessible to the central constituent entity control system. In some embodiments, the dynamic aggregated performance metric set may include representations of the subject entity performance metrics associated with a plurality of subject entities. For example, representations of the subject entity performance metrics comprising the dynamic aggregated performance metric set may include averages, medians, means, totals, distributions, and down-sampled representations.

The subject entity performance metrics comprising the dynamic aggregated performance metric set may be aggregated from a subset of subject entities comprising the subject entity performance data set. In some embodiments, the subset of subject entities may be selected based on a common or comparable entity characteristic. For example, the dynamic aggregated performance metric set may be aggregated from a subset of subject entities comprising a similar size, location, type, or constituent data entity set to the target entity. Further entity characteristics utilized to group a subset of subject entities may include a franchise affiliation associated with the data entities, or a performance grouping (e.g., quartile grouping) associated with the particular data entities.

In one non-limiting example, a dynamic aggregated performance metric set may be aggregated from a subset of subject entities having a similar inventory, or income to the target entity. In another non-limiting example, a dynamic aggregated performance metric set may be aggregated from a subset of subject entities having a similar location or proximity to a location as the target entity. In another non-limiting example, a dynamic aggregated performance metric set may be aggregated from a subset of subject entities having a common constituent data entity set or subset. In some examples, a dynamic aggregated performance metric set may be aggregated from the set or a subset of subject entities for a particular constituent data entity.

The dynamic aggregated performance metric set may be dynamically updated based on input from a user interfacing with the target entity optimization model framework. For example, due to updates to the associated target entity, updates to one or more of the subject entities, updates to the grouping criteria utilized to form the subset of subject entities comprising the dynamic aggregated performance metric set, and so on.

As used herein, a “central constituent entity control system,” refers to one or more computing devices (e.g., computers, servers, relays, routers, network access points, hosts, clients, communications network systems, storage systems, mobile devices, software applications, operating systems, or the like), configured to implement a target entity optimization model framework and store a dynamic aggregated performance metric set. In addition, the central constituent entity control system stores and/or accesses a constituent data entity metrics set. Although depicted within the central constituent entity control system, the constituent data entity metrics set and/or the dynamic aggregated performance metric set may be stored at a remote location from the central constituent entity control system and access through a network connection. For example, the constituent data entity metrics set and/or the dynamic aggregated performance metric set may be stored in a cloud storage system and accessible to the central constituent entity control system and access through a network connection.

As used herein, a “target entity optimization model framework,” refers to a computational framework within a central constituent entity control system utilizing one or more rules-based models to generate a recommended constituent data entity set and/or a balanced constituent data entity set based on one or more subject entity performance metrics and one or more target entity performance metrics.

A target entity optimization model framework may include a dynamic performance metric aggregation model. The dynamic performance metric aggregation model is configured to determine a subset of the set of subject entities based on one or more subject entity characteristics, subject entity performance metrics, and/or characteristics of the subject entity constituent data entity set. The dynamic performance metric aggregation model further aggregates data related to the subset of subject entities in to a dynamic aggregated performance metric set. The dynamic performance metric aggregation model may select the subset of subject entities based on one more entity characteristics in common with or similar to the target entity. In some embodiments, the subset of subject entities may be selected based on one or more constituent data entities in common with or similar to a constituent data entity contained in the target constituent data entity set associated with the target entity. In addition, the dynamic performance metric aggregation model may access constituent data entity data from the constituent data entity metrics set, related to the subset of the set of subject entities. Constituent data entity data may provide performance metrics related to one or more constituent data entities associated with one or more of the subject entities.

A target entity optimization model framework may include a target entity forecast model. A target entity forecast model is configured to receive target data associated with the target entity, for example, target entity characteristics, data related to the target constituent data entity set associated with a target entity, target entity performance metrics, and so on and generate a target entity forecast comprising forecast target entity performance metrics. The forecast target entity performance metrics may include predicted performance metrics, derived from manual user input, machine learning techniques, and/or forecast performance metrics derived from aggregated data of one or more subject entities. In some embodiments, the forecast performance metrics may be derived from a combination of manual user input and aggregated data of one or more subject entities. In some embodiments, the target data associated with the target entity may be input through a graphical user interface. In some embodiments, the target data associated with the target entity may be accessed from a server, database, or other storage mechanism accessible to the target entity optimization model framework. In some embodiments one or more portions of the target data may be forecast or predicted based on known information associated with the target entity.

A target entity forecast model may be configured to generate a target entity forecast in accordance with the amount of data particular to a target entity available. For example, in some embodiments, in which minimal data related to the target entity is available, holes or gaps in the data may be filled by an industry standard, a similar subject entity, an accumulation of data from subject entities, or other similar source.

A target entity optimization model may further include a forecast offset adjustment model. The forecast offset adjustment model may receive the dynamic aggregated performance metric set, the target entity forecast, and the initial target constituent data entity set associated with the target entity, and generate an offset index based on a difference between the target entity forecast and the dynamic aggregated performance metric set. An offset index may include data representing the difference between the subject entity forecast and the dynamic aggregated performance metric set. In addition, an offset index may include a new target constituent data entity set and/or an updated target constituent data entity set based on the offset index and the initial target constituent data entity set.

An updated constituent data entity set may comprise a set of one or more constituent data entities. For example, in some embodiments, one or more constituent data entities common to the subset of subject entities comprising the dynamic aggregated performance metric set may be selected for inclusion in an updated target constituent data entity set. In an instance in which a target entity system comprises an initial target constituent data entity set, the updated target constituent data entity set may be generated upon balancing the initial target constituent data entity set. For example, the updated target constituent data entity set may include additional constituent data entities that were added to the initial target constituent data entity set based upon the offset index, the updated target constituent data entity set may have constituent data entities removed from the initial target constituent data entity set, and/or one or more constituent data entities of the initial target constituent data entity set may be augmented or adjusted to create updated target constituent data entity set. In an instance in which a target entity comprises no constituent data entities in an associated initial target constituent data entity set, the updated target constituent data entity set may be generated without reference to any initial constituent data entities for the target entity (e.g., purely adding constituent data entities). In each instance, the updated target constituent data entity set may include parameters for each constituent data entity that are set based on the model analysis described herein.

As such, the forecast offset adjustment model may further be configured to generate an updated target constituent data entity set based on the offset index, relative to the initial target constituent data entity set. For example, the forecast offset adjustment model may compare the target entity constituent data entity set to the offset index to identify missing constituent data entities, added constituent data entities, and/or augmented constituent data entities. The forecast offset adjustment model may determine adjustments to be made to the initial target entity constituent data set, including adding constituent data entities, removing constituent data entities, and/or augmenting existing constituent data entities.

In one non-limiting example, a target entity optimization model framework may be utilized to adjust the supplemental product offerings associated with a target automobile dealership. For example, the target entity optimization model framework may access performance metrics from one or more subject automobile dealerships selected based on a common characteristic and/or supplemental product offering. In such an example, the target entity optimization model framework may recommend a set of supplemental product offerings and/or augmentations to an existing set of supplemental product offerings based on a comparison between the performance metrics of the target automobile dealership and the one or more subject automobile dealerships.

As used herein, an “offset index,” index refers to any data construct configured to indicate one or more differences between the performance of a target entity and one or more subject entities represented by a dynamic aggregated performance metric set. In some embodiments, an offset index may quantify performance metric differences between a target entity and one or more subject entities across a variety of individual performance metrics. An offset index may also indicate differences in the initial target entity constituent data entity set and subject entity constituent data entities associated with the subset of subject entities used to generate the dynamic aggregated performance metric set.

The offset index may further include a new target constituent data entity set comprising constituent data entities based on the dynamic aggregated performance metric set and/or an updated target constituent data entity set derived from an initial target constituent data entity set associated with a target entity.

In one non-limiting example, an offset index may indicate a difference in income per transaction between a target automobile dealership and an income per transaction of a dynamic aggregated performance metric set comprising performance metrics from a plurality of similar subject automobile dealerships. The offset index may further indicate differences in the supplemental product offering between the target automobile dealership and a representative set of constituent data entities associated with the dynamic aggregated performance metric set.

As used herein, “geolocation,” refers to any parameter, characteristic, feature, trait, attribute, demographic, etc. related to a geographic location of an entity (e.g., target entity, subject entity) and/or associated computing device. Geolocation may refer to a geographic location (e.g., latitude/longitude), city, state, region, country, etc. Geolocation may further refer to a relative location. For example, proximity to a city, an interstate, a retail location, or other identifying location. In one non-limiting example, geolocation may refer to the distance of an automobile dealership from a population center comprising more than a million people.

In some embodiments, a geolocation parameter may be associated with a location data value. A location data value is any value associated with a geolocation parameter of an entity. For example, a location data value may be the latitude/longitude of the entity. A location value may be the distance of the entity from an interstate, and so on. In some embodiments, the subset of subject entities included in the dynamic aggregated performance metric set may be based on a comparison of the location data value of each of the subject entities to a location data value of the target entity.

For example, a distance of a location data value of a subject entity from the location data value of the target entity may be determined. The distance may then be compared to a maximum threshold distance. In an instance in which the distance between the subject entity and the target entity is less than the maximum threshold distance, the subject entity may be included in the dynamic aggregated performance metric set.

Similarly, in some embodiments, a geolocation characteristic range may be defined based on a location data value of a target entity. For example, a target entity located 10 miles from a particular city may be compared to subject entities within a geolocation characteristic range between 5 miles and 15 miles from the particular city. In such an instance, subject entities in the set of subject entities between 5 miles and 15 miles from the particular city may be selected for inclusion in the dynamic aggregated performance metric set.

As used herein, a “size parameter,” refers to any parameter, characteristic, performance metric, feature, trait, demographic, etc. related to a size of a target or subject entity. A size parameter may refer to one or more parameters related to the size of a business, for example, performance metrics such as income or revenue or characteristics such as number of employees, size of inventory, etc. In some embodiments, the size parameter may also be related to the quantity of constituent data entities within a constituent data entity set associated with an entity.

A size parameter may be utilized to determine the subset of subject entities in the dynamic aggregated performance metric set. For example, a difference in a size parameter associated with a target entity and a size parameter associated with a subject entity may be determined. The difference may then be compared to a maximum difference threshold. In an instance in which the difference between the size parameter of the subject entity and the size parameter of the target entity is less than the maximum difference threshold, the subject entity may be included in the dynamic aggregated performance metric set.

For example, in an instance in which the target and subject entities are automobile dealerships, a size may represent a total automobile inventory. A difference between the total automobile inventory of a target entity and each of the subject entities may be calculated. If the difference is less than a maximum difference threshold, the subject entity may be included in the dynamic aggregated performance metric set. Some size parameter data may be used as a “characteristic” of an entity for demographic analysis and/or as a “performance metric” for optimization (e.g., maximizing sales).

As used herein, a “graphical user interface,” refers to any display, graphics, or other visual interface which a user can interact with an implementation of the target entity optimization model framework. As described herein, a graphical user interface may enable a user to input various data related to a target entity and/or subject entities. A user may directly input target entity characteristics, target constituent data entity sets, target entity performance metrics, and so on. A user may further select the target entity optimization model framework to autofill and/or predict unknown or undetermined data. In some examples, a user may utilize a graphical user interface to view and/or alter a target entity forecast. In some examples, both a subject entity forecast, and a target entity forecast may be updated dynamically based on input from a user through the graphical user interface.

### System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

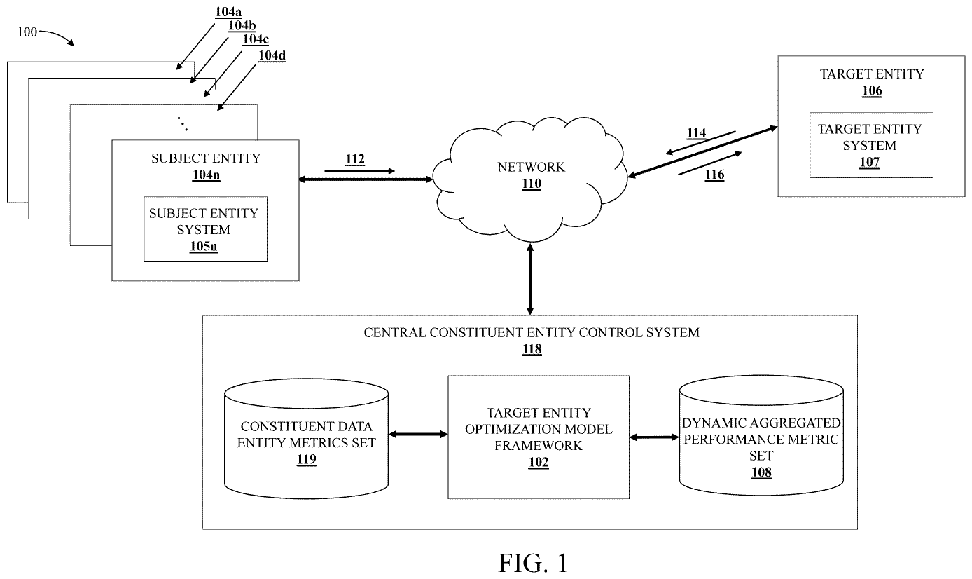

Referring now to FIG. 1, an example target entity optimization system 100 is illustrated. As depicted in FIG. 1, the example target entity optimization system 100 includes a network 110 communicatively connecting a target entity 106 comprising a target entity system 107, a plurality of subject entities 104a-104n each comprising a subject entity system 105a-105n, and a central constituent entity control system 118. As further depicted in FIG. 1, the central constituent entity control system 118 includes a target entity optimization model framework 102, at least one data repository comprising a dynamic aggregated performance metric set 108, and at least one data repository comprising a constituent data entity metrics set 119. In some embodiments, a single data repository or multiple data repositories may house the constituent data entity metrics set 119 and/or dynamic aggregated performance metric set 108. As further depicted in FIG. 1, subject entity data 112 is transmitted by the plurality of subject entities 104a-104n to the central constituent entity control system 118. Further, target data 114 is transmitted by the target entity 106 to central constituent entity control system 118. In addition, updated constituent data entity sets 116 are transmitted by central constituent entity control system 118 to the target entity 106.

As depicted in FIG. 1, the target entity optimization system 100 includes a target entity 106 comprising a target entity system 107. A target entity 106 comprises any unit, object, entity, or combination of units, objects, and entities, associated with one or more target entity characteristics and with a target constituent data entity set. The performance of a target entity 106 may be quantified in one or more performance metrics (e.g., target entity performance metrics). The target entity 106 further comprises a target entity system 107. The target entity system 107 may comprise a system of one or more computing apparatuses (e.g., apparatus 1100 illustrated in FIG. 11) configured to facilitate various functionalities of the target entity described herein The target entity 106 may be configured to transmit target data 114 comprising, in some embodiments, information related to the target entity characteristics, performance metrics, and/or target constituent data entity sets.

Various aspects of the target entity 106 may be updated or augmented to increase the performance of the target entity 106. For example, constituent data entities may be added to or removed from the target constituent data entity set to increase performance of the target entity 106. In addition, various aspects of one or more constituent data entities comprising the target constituent data entity set may be updated or augmented to increase the performance of the target entity 106.

In a non-limiting example, a target entity 106 may embody an automobile dealership. The performance metrics associated with the automobile dealership may include total income of the dealership, income per vehicle, add-on packages per vehicle sold, reserve income per transaction, and so on. The target constituent data entity set associated with the automobile dealership may include various products offered supplemental to automobiles, for example, insurance offerings, warranty offerings, accessory packages, additional products, and so on. The target entity characteristics associated with the automobile dealership may include average number of automobiles in inventory, average automobile sales, number of automobile trade-ins, average new automobile sales, average used automobile sales, average leases, average dealership income, average revenue, number of employees, and so on.

As further depicted in FIG. 1, the target entity optimization system 100 includes a plurality of subject entities 104a-104n each of the subject entities 104a-104n comprising a subject entity system 105a-105n. A subject entity 104 comprises any unit, object, entity, or combination of units, objects, and entities, for which information is available to the target entity optimization model framework 102. Each subject entity 104a-104n may be associated with one or more subject entity characteristics and with a subject entity constituent data entity set. The performance of each subject entity 104a-104n may be quantified in one or more performance metrics (e.g., subject entity performance metrics). The plurality of subject entities 104a-104n may be configured to transmit subject entity data 112 comprising, in some embodiments, information related to the subject entity characteristics, performance metrics and/or subject entity constituent data entity sets.

A subject entity 104a-104n may be configured to generate and output data relative to the performance of the subject entity 104a-104n, for example, to the target entity optimization model framework 102. In addition, data related to the subject entity constituent data entity sets included at each of the subject entities 104a-104n may be accessed by the target entity optimization model framework 102 and used to generate the dynamic aggregated performance metric set 108.

As depicted in FIG. 1, the subject entities 104a-104n comprise a subject entity system 105a-105n. The subject entity system 105a-105n may comprise a system of one or more computing apparatuses (e.g., apparatus 1100 illustrated in FIG. 11) configured to facilitate various functionalities of the subject entity 104a-104n described herein. The subject entity system 105a-105n may include a plurality of interconnected computational units, for example servers.

In a non-limiting example, a subject entity 104a-104n may embody an automobile dealership. The performance metrics associated with the automobile dealership may include total income of the dealership, income per vehicle, add-on packages per vehicle sold, reserve income per transaction, and so on. The subject entity constituent data entity set associated with the automobile dealership may include various products offered supplemental to automobiles, for example, insurance offerings, warranty offerings, accessory packages, additional products, and so on. The subject entity characteristics associated with the automobile dealership may include average number of automobiles in inventory, average automobile sales, number of automobile trade-ins, average new automobile sales, average used automobile sales, average leases, average dealership income, average revenue, number of employees, and so on.

As depicted in FIG. 1, the target entity optimization model framework 102 of the central constituent entity control system 118 may access subject entity data 112 from one or more subject entities 104a-104n, including performance metrics. In addition, to performance metrics from the plurality of subject entities 104a-104n, the target entity optimization model framework 102 may further access additional subject entity data 112 related to each subject entity 104a-104n, for example, the constituent data entities comprising the subject entity constituent data entity set.

The target entity optimization model framework 102 may be configured to generate a subject entity forecast based on the subject entity data 112 associated with each subject entity 104a-104n. For example, in some embodiments, the performance metrics included in the subject entity data 112 from the subset of subject entities may be aggregated into a dynamic aggregated performance metric set 108. In generating the dynamic aggregated performance metric set 108, the target entity optimization model framework 102 may determine a subset of subject entities from the plurality of subject entities 104a-104n based on a common entity characteristic, the constituent data entities in the subject entity constituent data entity set, performance metrics, or some other data related to the subject entities 104a-104n. The dynamic aggregated performance metric set may represent the performance data from the subset of subject entities. The dynamic aggregated performance metric set may be compared to the target entity 106 and/or the subject entity forecast to gauge the performance of the target entity 106.

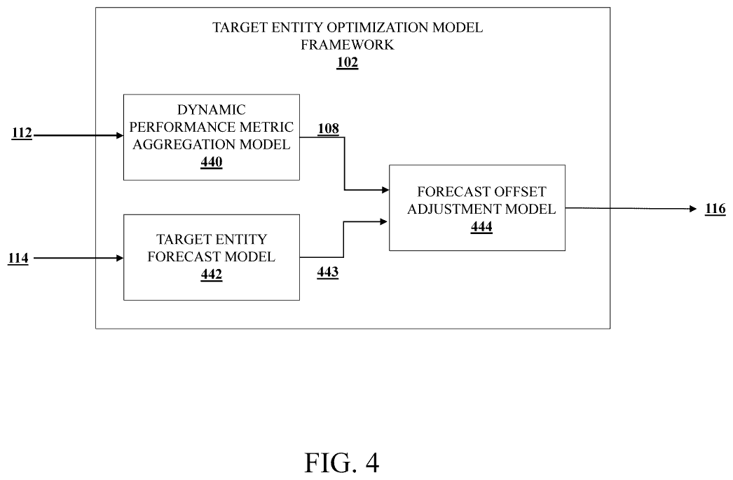

In some embodiments, the target entity optimization model framework 102 may further generate a target entity forecast based on data associated with the target entity 106. The target entity forecast may be compared to the subject entity forecast to determine an offset index and trigger a balancing of the target entity 106 target constituent data entity set. Generation of the offset index is further described in relation to FIG. 4.

As further depicted in FIG. 1, the central constituent entity control system 118 includes a constituent data entity metrics set 119. The constituent data entity metrics set 119 may comprise any data stored by or in association with the central constituent entity control system 118 and related to a constituent data entity. The constituent data entity metrics set 119 may include correlations (e.g., statistical data, such as averages, trends, or the like) between one or more constituent data entities and one or more particular performance metrics. The constituent data entity metrics set 119 may include data related to various constituent data entities tracked over time. The data included in the constituent data entity metrics set 119 may be gathered from or otherwise associated with various subject entities 104a-104n. For example, the constituent data entity metrics set 119 may be generated by and stored in association with the central constituent entity control system 118 during provision of the constituent data entities to one or more of the respective subject entities 104a-104n. In some embodiments, at least a portion of the data of the constituent data entity metrics set 119 may be labeled with the respective subject entities. In some embodiments, at least a portion of the data of the constituent data entity metrics set 119 may be subject entity agnostic (e.g., unlabeled data and/or aggregated, such as by correlation, or otherwise processed data associated with multiple subject entities). The target entity optimization model framework 102 may access the constituent data entity metrics included in the constituent data entity metrics set 119 when generating the dynamic aggregated performance metric set 108. The constituent data entity metrics set 119 may be combined with or used to supplement the subject entity constituent data entities provided by each subject entity 104a-104n.

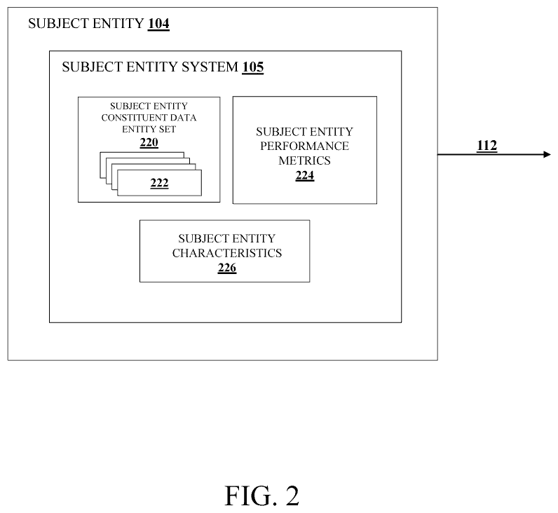

Referring now to FIG. 2, an example subject entity 104 comprising a subject entity system 105 is provided. As depicted in FIG. 2, the example subject entity system 105 includes a subject entity constituent data entity set 220 comprising a plurality of constituent data entities 222. The example subject entity 104 is further associated with subject entity characteristics 226 stored on a subject entity system 105. The example subject entity system 105 further includes subject entity performance metrics 224 associated with the subject entity 104 and is configured to output subject entity data 112.

As depicted in FIG. 2, the subject entity system 105 includes a subject entity constituent data entity set 220 comprising a plurality of constituent data entities 222. A constituent data entity 222 is any commodity, object, data, product, offering, or other service provided by a subject entity system 105 to an external consumer. A constituent data entity 222 may comprise a number of variable parameters, for example, a cost, a duration, a quantity, a scope, and so on. Each parameter of the constituent data entity 222 within the subject entity constituent data entity set 220 may be accessible to a target entity optimization model framework (e.g., target entity optimization model framework 102). In addition, a target entity optimization model framework may access the size of the constituent data entity set 220. In some embodiments, a dynamic aggregated performance metric set may be generated based on various aspects of a subject entity constituent data entity set 220 and the constituent data entities 222 included in the subject entity constituent data entity set 220. For example, the size of the subject entity constituent data entity set 220, the type of the constituent data entities 222 included in the subject entity constituent data entity set 220, the various parameters of the constituent data entities 222 included in the subject entity constituent data entity set 220 and so on.

As further depicted in FIG. 2, the subject entity system 105 includes subject entity characteristics 226 related to the subject entity 104. Subject entity characteristics 226 comprise any data construct configured to store one or more features, traits, attributes, demographics, or any other data identifying a subject entity 104 as belonging to an individual or group. The subject entity characteristics 226 associated with a subject entity 104 may be accessible to a target entity optimization model framework. In some embodiments, a dynamic aggregated performance metric set may be aggregated based on one or more subject entity characteristics 226. For example, the target entity optimization model framework may aggregate performance metrics based on the subject entity data 112 for all subject entities 104 having a subject entity characteristic 226 within a certain range (e.g., subject entities 104 having between 100 and 1000 employees).

As further depicted in FIG. 2, the subject entity system 105 includes subject entity performance metrics 224 associated with the subject entity 104. Subject entity performance metrics 224 comprise any statistics, information, facts, or other data representing the performance of the subject entity 104. Subject entity performance metrics 224 may relate to the speed, efficiency, financial performance, or any other aspect of a subject entity 104. In some examples, subject entity performance metrics 224 may be specifically related to income, income per time period, income per product sold, income per transaction, fee revenue, reserve per transaction, number of products sold, number of constituent data entities sold, saturation rate, penetration rate, and so on. The subject entity performance metrics 224 may be transmitted as performance metrics in the subject entity data 112 or may be otherwise accessible to a target entity optimization model framework.

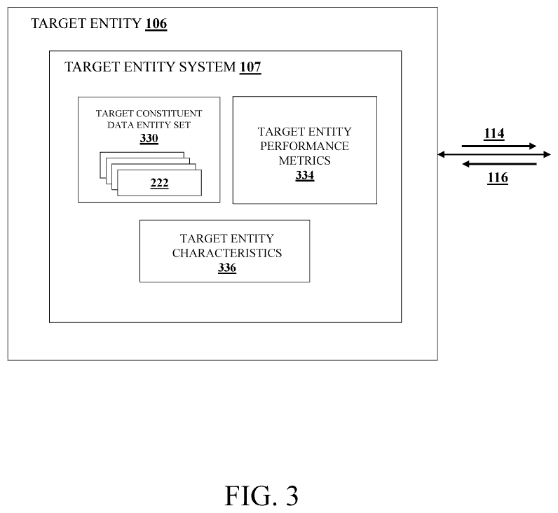

Referring now to FIG. 3, an example target entity 106 comprising a target entity system 107 is provided. As depicted in FIG. 3, the example target entity system 107 includes a target constituent data entity set 330 comprising a plurality of constituent data entities 222. The example target entity 106 is further associated with target entity characteristics 336 stored in the target entity system 107. The example target entity system 107 further includes target entity performance metrics 334 associated with the target entity 106 and is configured to output target data 114. In addition, the target entity system 107 is configured to receive updated constituent data entity sets from a target entity optimization model framework (e.g., target entity optimization model framework 102).

As depicted in FIG. 3, the target entity system 107 includes a target constituent data entity set 330 comprising a plurality of constituent data entities 222. As described herein, a constituent data entity 222 may comprise a number of variable parameters, for example, a cost, a duration, a quantity, a scope, and so on. Each parameter of the constituent data entity 222 within the target constituent data entity set 330 may be accessible to a target entity optimization model framework (e.g., target entity optimization model framework 102). In addition, a target entity optimization model framework may access the size of the target constituent data entity set 330. In some embodiments, the variable parameters of a constituent data entity 222 may be augmented or updated in conjunction with a balancing of a target constituent data entity set 330. For example, in some examples, one or more of the variable parameters of a constituent data entity 222 may be augmented.

As further depicted in FIG. 3, the target entity system 107 includes target entity characteristics 336 associated with the target entity 106. Target entity characteristics 336 comprise any data construct configured to store one or more features, traits, attributes, demographics, or any other data identifying a target entity 106 as belonging to an individual or group. The target entity characteristics 336 associated with a target entity 106 may be accessible to a target entity optimization model framework. In some embodiments, a dynamic aggregated performance metric set may comprise data aggregated from one or more subject entities (e.g., subject entity 104a-104n) comprising one or more subject entity characteristics (e.g., subject entity characteristics 226) in common or in close proximity to a target entity characteristic 336 of the target entity 106.

As further depicted in FIG. 3, the target entity system 107 includes target entity performance metrics 334 associated with the target entity 106. Target entity performance metrics 334 comprise any statistics, information, facts, or other data representing the performance of the target entity 106. Target entity performance metrics 334 may relate to the speed, efficiency, financial performance, or any other aspect of a target entity 106. In some examples, target entity performance metrics 334 may be specifically configured to include income, income per time period, income per product sold, income per transaction, fee revenue, reserve per transaction, number of products sold, number of constituent data entities sold, saturation rate, penetration rate, and so on. The target entity performance metrics 334 may be transmitted in the target data 114 to a network storage location, a target entity optimization model framework, or may be otherwise made accessible to a target entity optimization model framework.

In some embodiments, the target entity performance metrics 334 may be forecast based on input related to the current state of the target entity 106 and/or similarly situated subject entities. For example, a target entity forecast may be generated comprising predicted target entity performance metrics 334.

Referring now to FIG. 4, a block diagram of an example target entity optimization model framework 102 is provided. As depicted in FIG. 4, the target entity optimization model framework 102 includes a dynamic performance metric aggregation model 440 configured to receive subject entity data 112 from the plurality of subject entities and generate a dynamic aggregated performance metric set 108. The example target entity optimization model framework 102 further comprises a target entity forecast model 442 configured to receive target data 114 from the target entity (e.g. target entity 106) and generate a target entity forecast 443. As further depicted in FIG. 4, the target entity optimization model framework 102 includes a forecast offset adjustment model 444 configured to compare the dynamic aggregated performance metric set 108 and the target entity forecast 443 to generate an updated target constituent data entity set 116 based on an offset index.

As depicted in FIG. 4, the dynamic performance metric aggregation model 440 is configured to access subject entity data 112, including performance metrics associated with a set of subject entities (e.g., subject entities 104a-104n). In some embodiments, the performance metrics may be accessed directly from the subject entity system 105 and/or retrieved from a database comprising subject entity data for example, for a plurality of subject entities 104. The dynamic performance metric aggregation model 440 is further configured to generate a dynamic aggregated performance metric set 108 based on a subset of subject entities selected based on subject entity characteristics (e.g., subject entity characteristics 226), subject entity performance metrics (e.g., subject entity performance metrics 224), and/or aspects of the subject entity constituent data entity set (e.g., subject entity constituent data entity set 220). In some embodiments, the dynamic aggregated performance metric set 108 may include data representations of performance metrics associated with the subset of subject entities. Data representations of the performance metrics comprising the dynamic aggregated performance metric set 108 may include averages, medians, means, totals, distributions, down-sampled representations, and so on.

In addition, the dynamic performance metric aggregation model 440 may access constituent data entity data from the constituent data entity metrics set (e.g., constituent data entity metrics set 119 as depicted in FIG. 1), which constituent data entity metrics set may be related to the subset of the set of subject entities and/or to the constituent data entities (e.g., independently of any particular subject entity or associated with an aggregated group of subject entities). Constituent data entity data may provide performance metrics related to one or more constituent data entities associated with one or more of the subject entities.

In some embodiments, the dynamic aggregated performance metric set 108 may be dynamically updated based on input from a user interfacing with the target entity optimization model framework. For example, the dynamic aggregated performance metric set 108 may be dynamically updated due to updates to the associated target entity, updates to one or more of the subject entities, updates to the grouping criteria utilized to form the subset of subject entities comprising the dynamic aggregated performance metric set 108, updates to the constituent data entity metrics set 119, and other updates to data accessible by the target entity optimization model framework 102. In one example, a user may update a grouping criteria on a graphical user interface, causing the dynamic aggregated performance metric set 108 to be updated based on the updating grouping criteria.

The dynamic aggregated performance metric set 108 may further include one or more characteristics of the subject entity constituent data entity sets associated with the subset of subject entities. For example, the dynamic performance metric aggregation model 440 may aggregate all of the constituent data entities contained in at least one subject entity constituent data entity set of a subject entity in the subset of subject entities. In some embodiments, the dynamic performance metric aggregation model 440 may determine various statistics related to the constituent data entities contained in the subject entity constituent data entity set of the subject entities included in the dynamic aggregated performance metric set 108. For example, the dynamic performance metric aggregation model 440 may determine the most common subject entity, the most common group of subject entities, the most common configuration of constituent data entities, and/or statistics related to the variable parameters to the constituent data entities in the subset of subject entities included within the dynamic aggregated performance metric set 108. In some embodiments, such statistics related to the constituent data entities may be accessed at the constituent data entity metrics set 119.

As further depicted in FIG. 4, the target entity optimization model framework 102 includes a target entity forecast model 442 configured to receive target data 114 and generate a target entity forecast 443 comprising forecast target entity performance metrics. The forecast target entity performance metrics comprising the target entity forecast 443 may be based on target entity characteristics, data related to the target constituent data entity set associated with a target entity, target entity performance metrics, subject entity data, constituent data entity metrics set, or other data accessible by the target entity optimization model framework 102. In some embodiments, the target entity forecast 443 may be dynamically updated due to updates to one or more of the subject entities, updates to the target entity performance metrics, updates to the target entity characteristics, and so on. In one example, a user may update a target entity forecast 443 and/or target data 114 at a graphical user interface configured to interface with the target entity optimization model framework 102.

In some embodiments, a machine learning model may be utilized by a target entity forecast model 442 to generate a target entity forecast 443. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. A machine learning model may access various data sources to provide predicted outcomes, for example, subject entity data 112, the dynamic aggregated performance metric set 108, the constituent data entity metrics set, and other data related to the performance of one or more subject entities and corresponding constituent data entities. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised learning or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network).

A training dataset may be derived from the set of subject entities and historical data associated with the set of subject entities. For example, the subject entity characteristics and subject entity constituent data entity sets may be correlated with the subject entity performance metrics for a plurality of subject entities. In addition, data related to the constituent data entities, for example data stored in the constituent data entity metrics set, may be utilized in the training of a machine learning model.

In some embodiments, the machine learning model can be trained in real-time (e.g., online training) while in use. For example, a machine learning model may be trained based on reinforcement learning. A reinforcement learning may receive rewards or penalties based on actions taken or predictions. Reinforcement learning is based on rewarding desired behaviors and punishing undesired ones. A reinforcement learning model is configured over time to perform actions that lead to maximum reward. A reinforcement learning model includes an agent configured to take actions, receive rewards based on the actions, and update the machine learning model to maximize the received reward. In some embodiments, one or more subject entity performance metrics may be utilized as a reward parameter. In such an instance, the reinforcement learning model may determine inputs, to maximize the one or more subject entity performance metrics.

The machine learning models described above may make use of multiple ML engines, e.g., for analysis, recommendation generating, transformation, and other needs.

The system may train different machine learning models for different needs and different machine learning-based engines. The system may generate new models (based on the gathered training data) and may evaluate their performance against the existing models. Training data may include any of the gathered information (e.g., subject entity characteristics, subject entity constituent data entity sets, subject entity performance metrics, constituent data entity metrics), as well as information on actions performed based on the various recommendations (e.g., updated target constituent data entity sets).

The machine learning models may be any suitable model for the task or activity implemented by each machine learning-based engine. Machine learning models are known in the art and are typically some form of neural network. The term refers to the ability of systems to recognize patterns on the basis of existing algorithms and data sets to provide solution concepts. The more they are trained, the greater knowledge they develop.

The underlying machine learning models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

Alternatively, machine learning models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders) to generate definitions and elements.

In various embodiments, the machine learning models may undergo a training or learning phase before they are released into a production, runtime, or classification phase or may begin operation with models from existing systems or models. During a training or learning phase, the machine learning models may be tuned to focus on specific variables, to reduce error margins, or to otherwise optimize their performance. The machine learning models may initially receive input from a wide variety of data, such as the gathered data described herein.

A classifier algorithm estimates a classification model from a set of training data. The classifier algorithm uses one or more classifiers and an associated algorithm to determine a probability or likelihood that a set of data belongs to another set of data. A decision tree model where a target variable can take a discrete set of values is called a classification tree (e.g., and therefore can be considered a classifier or classification algorithm).

A supervised model or predictive model is an estimate of a mathematical relationship in which the value of a dependent variable is calculated from the values of one or more independent variables. The functional form of the relationship is determined by the specific type (e.g., decision tree, Generalized Linear Model, gradient boosted trees) of supervised model. Individual numeric components of the mathematical relationship are estimated based on a set of training data. The set of functional forms and numerical estimates a specific type of supervised model can represent is called its “hypothesis space”.

During operation of the target entity optimization model framework 102, various sources of data may be continuously or periodically updated. For example, performance metrics, characteristics, and/or constituent data entities associated with the set of subject entities may be continuously or periodically updated. Similarly, performance metrics, characteristics, and/or constituent data entities associated with the target entity may be continuously or periodically updated. In some embodiments, the target entity optimization framework may refresh or renew such data previous to generating the dynamic aggregated performance metric set 108 and/or the target entity forecast 443. Regularly updating the data utilized by the target entity optimization model framework 102 ensures the target entity optimization model framework 102 is capable of generating real-time predictions and recommendations. As used herein, “periodically” may refer to set time intervals, such as hourly, daily, weekly, monthly, or the like and/or in response to certain triggers, such as a request sent by the central constituent entity control system 118 or a push from one or more of the subject or target entities. Such update frequencies may occur simultaneously (e.g., for each subject entity at the same time), staggered (e.g., at the same interval but different times), and/or asynchronously (e.g., at independent timings), including according to different frequencies (e.g., one data type or value may update at set intervals while another updates continuously or in response to a trigger).

As further depicted in FIG. 4, the target entity optimization model framework 102 includes a forecast offset adjustment model 444 configured to receive the dynamic aggregated performance metric set 108 and the target entity forecast 443 and generate an offset index representing one or more differences between the dynamic aggregated performance metric set 108 and the target entity forecast 443. The forecast offset adjustment model 444 may utilize any mechanism to compare the target entity forecast 443 with the dynamic aggregated performance metric set 108, for example, rule-based algorithms, machine learning models, and/or manual-based comparisons. For example, in some embodiments, the dynamic aggregated performance metric set 108 may include one or more constituent data entities and/or constituent data entity characteristics most common among the subset of subject entities used to determine the dynamic aggregated performance metric set 108. The forecast offset adjustment model 444 may determine constituent data entities commonly found in similarly situated subject entities missing from the target constituent data entity set associated with the target entity. Similarly, the forecast offset adjustment model 444 may determine constituent data entities not commonly found in similarly situated subject entities but present in the target constituent data entity set associated with the target entity. The forecast offset adjustment model 444 may further identify constituent data entity parameter ranges common to the subset of subject entities and further identify constituent data entities of the target constituent data entity set outside of the identified constituent data entity parameter ranges. The forecast offset adjustment model 444 may further quantify the difference in performance metrics between the dynamic aggregated performance metric set 108 and the target entity forecast 443. In addition to comparisons with the subset of subject entities, in some embodiments, the forecast offset adjustment model 444 may compare constituent data entities of the target data entity to the whole of the subject entities for which the forecast offset adjustment model 444 may access data. In some embodiments, certain statistics and/or characteristics may be derived from the set of subject entities for comparison to the constituent data entities associated with the target entity. In some embodiments, one or more weighted algorithms may be used to transform and compute the index results.

The offset index generated by the forecast offset adjustment model 444 comprises any data construct configured to identify the differences between the dynamic aggregated performance metric set 108 and the target entity forecast 443 as determined by the forecast offset adjustment model 444. For example, the offset index may list potential constituent data entities to be added to or removed from the target constituent data entity set based on the comparison. The offset index may further identify various parameters of the constituent data entities comprising the target constituent data entity set which may be augmented based on a comparison with the dynamic aggregated performance metric set 108. In some embodiments, the offset index may comprise a predicted optimal target constituent entity set and/or a predicted difference between a predicted optimal target constituent entity set and an initial target constituent entity set which may be used to update the initial target constituent entity set. The predicted optimal target constituent entity set and/or the predicted difference may include predictions associated with each individual constituent data entity and/or parameters associated therewith.

The offset index may further quantify the difference in performance metrics and/or the predicted change in performance metrics based on each identified difference. For example, in some embodiments, the offset index may indicate a plurality of adjustments to the target constituent data entity set based on the comparison of the dynamic aggregated performance metric set 108 and the target entity forecast 443. For example, a first update may be to add a constituent data entity to the target constituent data entity set. A second update may be to change a variable parameter of an existing constituent data entity in the target constituent data entity set. The offset index may indicate the predicted change in performance metrics based on the first update and separately provide the predicted change in performance metrics based on the second update.

As depicted in FIG. 4, the forecast offset adjustment model 444 may be configured to generate an updated target constituent data entity set 116 based on the offset index. In an instance in which a target entity does not have an initial target constituent data entity set, an updated target constituent data entity set 116 may be generated based on the constituent data entities common to the subset of subject entities that optimizes one or more performance metrics. Various other relevancy analyses may be performed to identify the subset of subject entities. Thus, an updated target constituent data entity set 116 may comprise a set of one or more constituent data entities and corresponding parameter settings recommended for a target entity primarily based on the dynamic aggregated performance metric set 108. The updated target constituent data entity set 116 may be utilized by a target entity currently without an existing target constituent data entity set, or which desires to start with a fresh constituent data entity set.

The target entity optimization model framework 102 may be further configured to generate an updated target constituent data entity set 116, relative to an initial target constituent data entity set. For example, the forecast offset adjustment model 444 may utilize the identified missing or additional constituent data entities in the target constituent data entity set to add or remove constituent data entities from the initial target constituent data entity set. In addition, the forecast offset adjustment model 444 may utilize the identified parameter ranges of the constituent data entities to update or adjust the constituent data entities in the target entity. The forecast offset adjustment model 444 may consider costs and/or performance hits associated with on-boarding a new constituent data entity at a target entity and/or off-boarding an existing constituent data entity from a target entity. The balanced updated constituent data entity set 116 may be received at a target entity triggering a balancing of the target constituent data entity set.

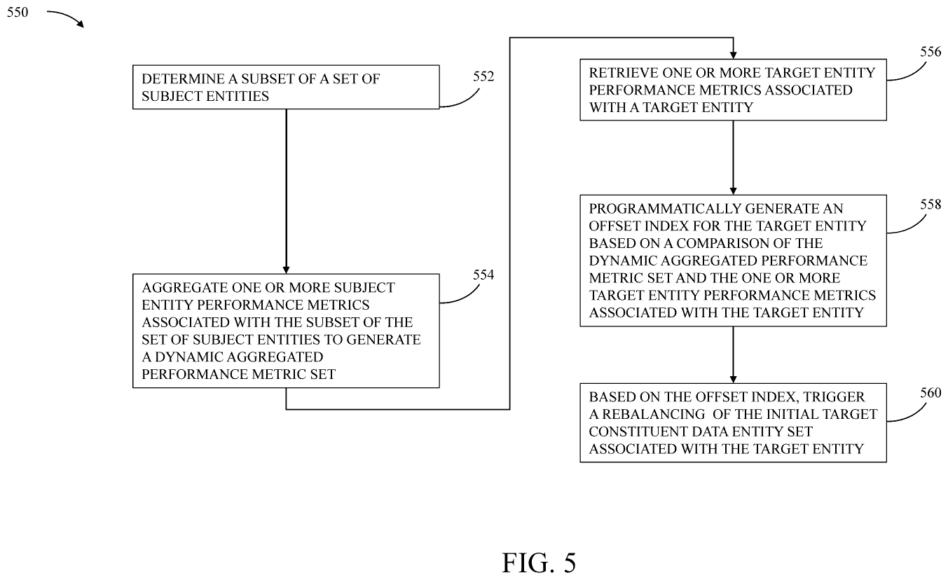

Referring now to FIG. 5, an example process 550 for triggering a balancing of a target constituent data entity set (e.g., target constituent data entity set 330) is provided. At block 552, the target entity optimization model framework (e.g., target entity optimization model framework 102) determines a subset of a set of subject entities (e.g., subject entities 104a-104n) each subject entity being associated with one or more subject entity characteristics (e.g., subject entity characteristics 226), and each subject entity comprising a subject entity constituent data entity set (e.g., subject entity constituent data entity set 220) comprising a subject entity subset of a plurality of constituent data entities (e.g., constituent data entity 222); and one or more subject entity performance metrics (e.g., subject entity performance metrics 224.

The set of subject entities may include a portion of or all subject entities to which the target entity optimization model framework may access subject entity data, including subject entity constituent data entity sets, subject entity performance metrics, and/or subject entity characteristics. In some embodiments, the target entity optimization model framework may access the subject entity data directly from the subject entity systems associated with the subject entity. In some embodiments, the target entity optimization model framework may access subject entity data through a database or repository configured to aggregate and/or store subject entity data from connected subject entities.

As described herein, the target entity optimization model framework may utilize any method for determining a subset of subject entities from the set of subject entities. In some embodiments, the subset of subject entities may be selected based on common or comparable parameters, such as a common or comparable characteristic (e.g., size, location, etc.), constituent data entity(ies), performance metric(s), constituent data entity variable parameters, and/or other constituent data entity parameters. For example, the subset of subject entities may comprise subject entities having a similar size, location, type, or constituent data entity set to the target entity.

The target entity optimization model framework may derive certain parameters, or ranges thereof to be included in the subset of subject entities relative to the selected common or comparable entity parameters based on data accessible to the target entity optimization model framework. In some embodiments, ranges may be determined automatically, for example, within a percentage (e.g., within 10% of the parameter) or absolute value (e.g., within twenty miles) of a selected common or comparable parameter. In some embodiments, ranges may be specified by a user, for example, through a graphical user interface.

As a non-limiting example, in an instance in which a location of a target entity is specified as a common or comparable entity parameter, all target entities within twenty miles may be selected for inclusion in the subset of subject entities.

In some embodiments, a plurality of ranges may be determined, for example a first range based on a location parameter of the target entity and a second range based on a size parameter of the target entity. A user may prioritize and/or specify preferences between multiple ranges.

Once the one or more ranges and/or common parameters are determined, the target entity optimization model framework may determine a subset of all subject entities that meet the criteria of one or more specified ranges and/or common parameters. In one non-limiting example, a size parameter range, a location parameter range, and a specific constituent data entity (and/or one or more performance metrics associated with any of the foregoing) may be determined. In one embodiment, the target entity optimization model framework may select subject entities for inclusion in the subset of subject entities that are within the size parameter range, and within the location parameter range, and that include the specific constituent data entity. In one embodiment, the target entity optimization model framework may select subject entities for inclusion in the subset of subject entities that are within the size parameter range, or within the location parameter range, or that include the specific constituent data entity.

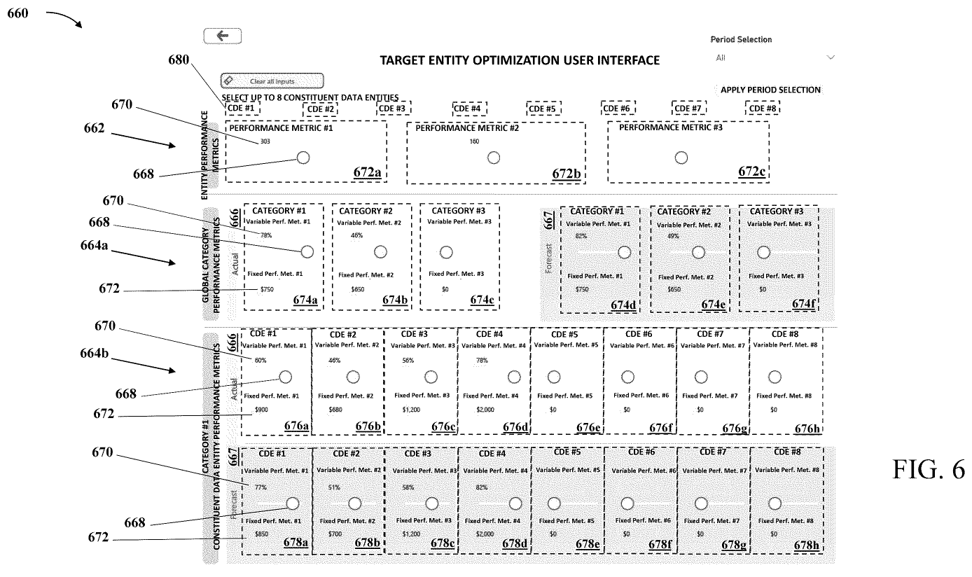

In some embodiments, the target entity data (e.g., target entity constituent data entity sets, target entity performance metrics, target entity characteristics) may be directly accessible by the target entity optimization model framework through the target entity system associated with the target entity. In some embodiments, the target entity data may be provided to the target entity optimization model framework by a user through a graphical user interface, such as the graphical user interfaces described in relation to FIG. 6-FIG. 10.

In one non-limiting example, the subset of subject entities may comprise subject entities having a similar inventory, or income to the target entity. In another non-limiting example, the subset of subject entities may comprise subject entities having a similar location or proximity to a location to the target entity. In another non-limiting example, the subset of subject entities may comprise subject entities having a common constituent data entity set or subset. In some examples, the subset of subject entities may comprise subject entities having a particular constituent data entity in its subject entity constituent data entity set. At block 554, the target entity optimization model framework aggregates the one or more subject entity performance metrics associated with the subset of the set of subject entities to generate a dynamic aggregated performance metric set (e.g., dynamic aggregated performance metric set 108).

The target entity optimization model framework may utilize the subset of subject entities (or full set of subject entities if utilized) to aggregate performance metrics, entity characteristics, constituent data entity data, and/or other data related to the subject entities and/or constituent data entities included in the subset of subject entities. For example, the target entity optimization model framework may access through a network connection the subject entity system for each subject entity included in the subset of subject entities. In some embodiments, data related to the subject entities may be stored in a repository or database accessible to the subject entities. The subject entities and/or the repository or database may periodically update the subject entity data stored in the repository or database with updated subject entity data. In such an instance, the target entity optimization model framework may access through a network connection data related to the subset of subject entities from the database or repository. Network access to various subject entity systems and/or repositories or databases from the target entity optimization model framework may be facilitate through any network access protocol, for example, direct memory access (DMA), file transfer protocol (FTP), hypertext transfer protocol (HTTP), simple mail transfer protocol (SMTP), or another network data transfer protocol.

The target entity optimization model framework may store various data associated with the subset of subject entities and store the data in a dynamic aggregated performance metric set. For example, the target entity optimization model framework may retrieve one or more performance metrics from each of the subject entities of the subset of subject entities. Further, the target entity optimization model framework may retrieve subject entity characteristics and data related to subject entity constituent data entity sets for each of the subject entities comprising the subset of subject entities.

In some embodiments, the target entity optimization model framework may generate statistical data based on the retrieved data corresponding to the subset of subject entities. For example, the target entity optimization model framework may determine averages, medians, means, or totals with respect to one or more data parameters retrieved from the subset of subject entities. In some embodiments, the target entity optimization model framework may generate a statistical distribution for one or more parameters of the subset of subject entities. In addition, the target entity optimization model framework may determine statistical data related to the constituent data entities included in the subject entity constituent data entity sets of the subject entities included in the subset of subject entities. For example, the target entity optimization model framework may determine common constituent data entities, common bundles of constituent data entities, and further statistical data related to the makeup of the subject entity constituent data entity sets.

Further, the target entity optimization model framework may retrieve constituent data entity metrics, for example, from a constituent data entity metrics set, relative to the constituent data entities included in the subject entity constituent data entity sets of the subset of subject entities.

At block 556, the target entity optimization model framework retrieves one or more target entity performance metrics (e.g., target entity performance metrics 334) associated with a target entity (e.g., target entity 106), the target entity comprising an initial target constituent data entity set (e.g., target constituent data entity set 330), and one or more target entity performance metrics (e.g., target entity performance metrics 334). The initial target constituent data entity set comprising a target entity subset of the plurality of constituent data entities. As described herein, the target entity may comprise an initial target constituent data entity set. The initial target constituent data entity set represents the target constituent data entities associated with a target entity before a balancing is triggered. The target entity may further include one or more target entity performance metrics. The one or more target entity performance metrics represent the performance of the target entity as determined by accessible target entity performance data and/or as input by a user at a user interface.

The target entity optimization model framework may access various target data associated with the target entity, for example, by network connection to the target entity system. The target data may include target entity performance metrics, a target constituent data entity set, target entity characteristics, or the like. The target entity optimization model framework may generate a target entity forecast based on the target entity data. In some embodiments, the target entity optimization model framework may forecast performance metrics. For example, the target entity optimization model framework may project the performance metrics associated with a target entity based on the target data associated with the target entity. Target data may include current performance metrics of the target entity, the target constituent data entity set associated with target entity, target entity characteristics of the target entity, or the like. The target entity optimization model framework may utilize various data repositories, such as the dynamic aggregated performance metric set and/or the constituent data entity metrics set, to determine the forecast performance metrics for the target entity. A user may adjust one or more parameters of the target data associated with the target entity to generate updated target entity performance metrics. In addition, a user may adjust projected target entity performance metrics using a graphical user interface.

At block 558, the target entity optimization model framework programmatically generates an offset index for the target entity based on a comparison of the dynamic aggregated performance metric set and the one or more target entity performance metrics associated with the target entity.

In some embodiments, the target entity optimization model framework may determine optimal performance metrics based on the dynamic aggregated performance metric set. As discussed herein, the dynamic aggregated performance metric set may be compiled from subject entities similarly situated to the target entity in at least one representative characteristic or other data point(s). Thus, by aggregating certain parameters from the subset of subject entities into the dynamic aggregated performance metric set, certain correlations between the dynamic aggregated performance metric set and the target entity may be drawn. For example, the target entity may be compared to the average performance of subject entities in the subset of subject entities. In some embodiments, the target entity may be compared to the maximum performance of subject entities in the subset of subject entities. The offset index may be generated based on one or more of such comparisons.

The offset index identifies differences between the dynamic aggregated performance metric set and the target entity. For example, the target entity optimization model framework may compare one or more statistics associated with the dynamic aggregated performance metric set with the target entity performance metrics, the target entity characteristics, and/or the target constituent data entity set. The offset index may represent such differences. In one non-limiting example, the target entity optimization model framework may determine an average income of the subset of subject entities included in the dynamic aggregated performance metric set. The target entity optimization model framework may further compare the average income with the current income or projected income of the target entity. The determined difference may be stored in the offset index.

The offset index may further quantify, rank, weight, or otherwise indicate a rating associated with the identified differences. For example, differences between the dynamic aggregated performance metric set and the target entity performance metrics may be ranked based on the degree of target entity deviation from the dynamic aggregated performance metric set. Further, a preference or weighting may be associated with a particular performance metric or other difference indicated by the offset index. In some embodiments, a user may identify a preference or weighting for a performance metric through a user interface.

At block 560, based on the offset index, the target entity optimization model framework triggers a balancing of the initial target constituent data entity set associated with the target entity to generate an updated target constituent data entity set, the balancing comprising augmenting at least one constituent data entity of the target entity subset of the plurality of constituent data entities or adding at least one additional constituent data entity of the plurality of constituent data entities to the target entity subset of the plurality of constituent data entities.

Based on the offset index, the target entity optimization model framework may generate an updated target constituent data entity set. For example, the target entity optimization model framework may identify one or more constituent data entities commonly included in the subset of subject entities but not included in the initial target constituent data entity set. The target entity optimization model framework may generate an updated target constituent data entity set including the additional one or more constituent data entities. In addition, the target entity optimization model framework may identify one or more parameter settings of an existing constituent data entity included in the initial target constituent data entity set that is adversely affecting the performance of the target entity compared to the subset of subject entities. The offset index may indicate a parameter change (e.g., augmentation) to the identified constituent data entity, and a constituent data entity with the indicated parameter change may be added to the target constituent data entity set. For example, an augmentation to one or more existing constituent data entities of the target entity may include modifying the amount or proportion of each constituent data entity allocated to the target entity system. In some embodiments, the updated target constituent data entity set includes a complete list of the constituent data entities to be offered by a target entity. In some embodiments, the updated target constituent data entity set includes a difference between the initial target constituent data entity and the recommended constituent data entity based on the offset index.

The target entity optimization model framework may consider preferences and/or weightings associated with the constituent data entities, for example, as provided by a user through a graphical user interface. In some embodiments, a user may identify a preference or weighting for constituent data entities particular to a target entity. The target entity optimization model framework may further consider costs and/or performance hits associated with on-boarding a new constituent data entity at a target entity and/or off-boarding an existing constituent data entity from a target entity. The updated constituent data entity set may be received at a target entity triggering a balancing of the target constituent data entity set.

In an instance in which there is no initial target constituent data entity set, the updated target constituent data entity set may be based primarily on the statistical conclusions drawn from the subset of subject entities comprising the dynamic aggregated performance metric set. In such an instance, the balancing operations may simply include integrating the updated constituent data entity set into the target entity system.

In an instance in which an initial target constituent data entity set is associated with the target entity, a balancing of the initial target constituent data entity associated with the target entity occurs. Balancing may include adding and/or subtracting constituent data entities to the initial target constituent data entity set. Such balancing may include allocating one or more of such constituent data entities at the central constituent entity control system 118 for the target entity, and/or may include transmitting operational data associated with such constituent data entity to the target entity system, which operational data may reconfigure the target entity system to use and allocate the constituent data entity. Balancing may further include augmenting parameters of one or more constituent data entities comprising the initial target constituent data entity set. Augmenting parameters may include reconfiguring one or more variable parameters of one or more target constituent data entities based on the offset index.

The balancing process may be triggered by a target entity optimization model framework indicating to a target entity, that an updated target constituent data entity set is available. An indication may be transmitted by a target entity optimization model framework over a network interface. In some embodiments, the target entity optimization model framework may be configured to automatically update the target constituent data entity set based on the updated target constituent data entity set. In such an embodiment, the target entity optimization model framework may be granted direct access to modify the target constituent data entity set associated with the target entity system. In this way, periodic or regular updates to the target constituent data entity set may be implemented. For example, updates to the target constituent data entity set may be made in real time.

In some embodiments, the target entity system may require approval of the updated target constituent data entity set. Approval may be authorized by the target entity system, for example, if the changes indicated by the updated target constituent data entity set are within a predetermined range. In some embodiments, approval may be authorized by a user or administrator at a user interface. For example, through a graphical user interface, or pop-up window.

Referring now to FIG. 6, an example target entity optimization user interface 660 is provided. A target entity optimization user interface 660 comprises a graphical user interface configured to enable interaction with a target entity optimization model framework at a user device, such as a mobile phone, laptop, computer, or other user device. In the depicted embodiment, the target entity optimization user interface 660 facilitates input and review of various performance metrics and characteristics associated with the target entity, which may be used by the framework to generate downstream functions as described herein. In some embodiments, a similar interface may be configured for input, review, and/or adjustment of data associated with any subject entity. In some embodiments, the target constituent data entity set may be updated (e.g., balanced) in real time as the target entity optimization user interface 660 is manipulated. In some embodiments, an execution button must be selected to trigger the updating.

The depicted target entity optimization user interface 660 includes a target entity performance metrics input bar 662 comprising a plurality of input mechanisms enabling a user to input target entity performance metrics 672a-c of the target entity. For example, the target entity performance metrics input bar 662 may facilitate display, review, and/or adjustment of one or more size parameters (e.g., volume, sales, etc.). In some embodiments, the target entity performance metrics 672a-c may be auto populated based on data available to the target entity optimization model framework. In some embodiments, the target entity performance metrics 672a-c may be input manually through one or more text fields 670 and/or dynamic adjustment elements (e.g., slider 668). In some embodiments, the dynamic adjustment element 668 may be linked to the text field 670 such that manual modification of either of the two also modifies the other. In some embodiments, the text field 670 may not be directly editable (e.g., only via the dynamic adjustment element). In some embodiments, the target entity performance metrics 672a-c may be both auto-populated and manipulable via the interface. Various target entity performance metrics 672a-c may be dynamically enabled and disabled using toggle switches (not shown). In some embodiments, the auto populated data comprising the target entity performance metrics input bar 662 may be manually adjusted by a user (e.g., to adjust the actual values or generate a predictive session with hypothetical values). Any adjustment to the target entity performance metrics 672a-c through the target entity optimization user interface 660 may trigger a recalculation of the target entity forecast and/or subject entity forecast, triggering a balancing of the balanced constituent data entity set. In addition, dynamic enabling and disabling of various target entity performance metrics, performance metrics, and constituent data entities may automatically trigger a balancing operation based on the newly provided input or may trigger such operation in response to a trigger signal (e.g., selection of a balancing element via the interface). In some embodiments, the interface may further include entity characteristics input sections.

As depicted in FIG. 6, various target entity performance metrics and constituent data entity sections may be disabled and/or left blank (e.g., constituent data entity nos. 5-8 labeled 676e-h and 678e-h and target entity performance metric #3 labeled 672c). Disabling a target entity performance metric (e.g., target entity performance metric #2) by removing the text from the text field or by toggling the associated toggle switch (e.g., moving a slider to zero or toggling a binary switch), may remove the particular target entity performance metric from the analysis or indicate a zero input. For example, a dynamic aggregated performance metric set previously generated based on the target entity performance metric may be regenerated without considering the particular target entity performance metric (e.g., by indicating that the target entity has zero of the performance metric or by instructing the system to disregard the performance metric entirely). The framework may thereby generate an offset index or other output, which may include an instruction to enable one or more performance metrics, constituent data entities, categories, or the like. In the depicted embodiment, the constituent data entities may be chosen via toggle icons 680 at the top of the screen, which may populate the constituent data entities into each of the constituent entity performance metric categories as discussed below. In some embodiments, the target entity optimization user interface 660 may automatically enable or disable the respective features of the interface based on the information received for the respective target entity (e.g., if the target entity only uses or has data associated with four constituent data entities, only the four available data entities will be enabled or otherwise include data in the interface).

The rebalancing operation may additionally be performed based on the data available to the central constituent entity control system, even in an instance in which various target entity data is unknown, missing, unspecified, or unavailable to the target entity optimization model framework. In the absence of certain data parameters or access to only limited target entity data, the target entity analysis and balancing may be performed with the available data. In some instances, gaps in the data may be filled by access to subject entity data and/or constituent data entity data included in the constituent data entity metrics set. Performing analysis even when minimal target entity data is available by filling the gaps in data may enable recommended balancing of a target entity to provide immediate improvements without experimentation or testing.

Further, various sources of data may be continuously or periodically updated, for example, performance metrics, characteristics, and constituent data entities associated with the set of subject entities may be continuously or periodically updated. Updates to various data sources may trigger balancing operations of the target entity and/or trigger updates to the target entity optimization user interface 660. Such real-time feedback, facilitates rapid, automated analysis and rapid on-the-fly reconfiguration of a target entity.

With continued reference to FIG. 6, the target entity optimization user interface 660 further includes one or more global category target entity performance metrics input bars 664a and one or more category target entity performance metrics input bars 664b. Each corresponding bar 664a, 664b may include an actual (e.g., current or historical) input section 666 and a forecast (e.g., future estimated) input section 667. The target entity performance metrics input bars 664a, 664b comprise a plurality of input mechanisms enabling a user to view, adjust, enable/disable, or input target entity performance metrics of the target entity. In some embodiments, the target entity performance metrics may be auto populated based on input data and other data available to the target entity optimization model framework (e.g., received via the target entity system 107 and/or constituent data entity metrics set 119 shown in FIG. 1). In the depicted embodiment, the global category target entity performance metrics input bar 664a defines categories 674a-f of performance for the entire entity (e.g., each category may include multiple constituent data entities therein). In some embodiments, each category 674a-f may correspond to one of the input entity performance metrics (although not all entity performance metrics may be subject to input, such as location). For example, in one embodiment, the target entity performance metrics 672a-672c may correspond to different types of vehicle transaction (e.g., new, used, leased), and the categories 674a-f of global category performance metrics 664a may correspond to a metric associated with each of the new, used, and leased vehicles, such as financing information. Each of the category target entity performance metrics input bars 664b may then be configured to display and/or receive inputs associated with the performance of each constituent data entity in each category. In some embodiments, global category performance input and/or display of the constituent data entities across all categories may additionally or alternatively be facilitated via the target entity optimization user interface 660. In some embodiments, multiple global category performance metrics and/or multiple category performance metrics bars may be provided.

In some embodiments, the target entity performance metrics may be input manually through one or more text fields and/or dynamic adjustment elements 668 (e.g., sliders, radio buttons, toggles, or the like). In some embodiments, the auto populated data comprising the target entity performance metrics may be manually adjusted by a user. In some embodiments, any adjustment to the target entity performance metrics may trigger a recalculation of any dependent fields. Similarly, in some embodiments, updating one or more performance metrics may trigger a recalculation of any dependent fields. In some embodiments, the various fields may be independent. For example, in some embodiments, updating one or more target entity performance metrics 672a-c may trigger an update of one or more of the target entity forecasts 674d-f, 678a-h, and/or may trigger a balancing of the balanced constituent data entity set. In addition, dynamic enabling and disabling of various performance metrics may automatically trigger a balancing operation based on the newly provided input.

One or more of the various categories 674a-f and/or constituent data entities 676a-h, 678a-h of the target entity performance metric bars 664a, 664b of the target entity optimization user interface 660 may include multiple performance metrics. For example, each of the depicted interface elements includes a variable performance metric 670 and a fixed performance metric 672. In some embodiments, either of the variable performance metric 670 and/or the fixed performance metric 672 may be editable in the interface and/or automatically populated by the system. The variable performance metric 670 may include a variable that may change over time or may otherwise be affected by system performance (e.g., a penetration rate), and the fixed performance metric 672 may include a static data point that may generally be independent of system performance (e.g., output per transaction, income per contract, etc.). In some embodiments, the dynamic adjustment element 668 may be configured to adjust the variable performance metric 670 (in addition to or instead of text based input), while the fixed performance metric is unchangeable or uses text-based input.

The forecast sections 667 of the respective performance metric bars 664a, 664b, as discussed above, may include forecasted performance metrics for the respective data points. In some embodiments, the forecast sections 667 may be wholly or partly populated by data from other subject entities (e.g., the subset of entities chosen for the dynamic aggregated performance metric set). For example, the forecast sections 667 may comprise an aggregated (e.g., average) performance metric from the subset scaled according to one or more of the target entity performance metrics. In some embodiments, the forecast sections 667 may be manually or automatically populated with forecast performance metrics of the target entity itself. As described herein, the forecast may be dynamically updated based on interactions by a user with the target entity optimization model framework through the target entity optimization user interface 660, may be generated automatically by the framework, and/or may be retrieved from one or more of the described repositories. Updates to the subject entity forecast may be dynamically displayed on the forecast sections 667 in response to changes to one or more other portions of the interface, including in real time or upon selection of a trigger element on the interface.

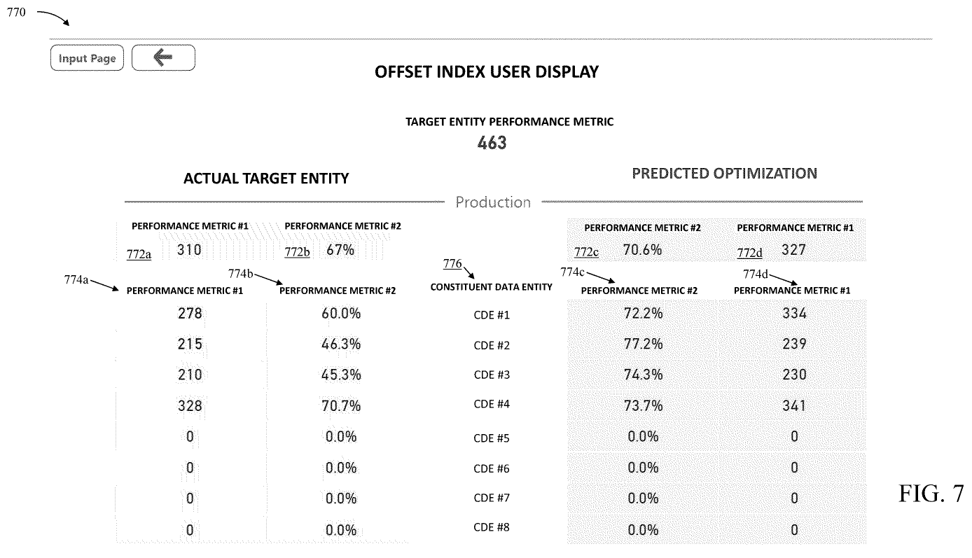

Referring now to FIG. 7, an example of a first portion of an offset index user display 770 is provided with various features generated and/or displayed based on the aforementioned features of FIG. 6. As depicted in FIG. 7, following analysis by the framework, the example offset index user display 770 displays various actual target entity performance metrics 772a-b, 774a-b corresponding to the actual current state of the target entity for comparison with various predicted opportunity performance metrics 772c-d, 774c-d after optimization that are generated via the various framework processes described herein. In the depicted embodiment, the display 770 includes global performance metrics 772a-d (e.g., total transactions 772a, 772d and penetration rate 772b, 772c) as well as the performance metrics 774a-d for each of the corresponding constituent data entities 776. While the final four constituent data entities are zero for both the actual and predicted data sets, in some embodiments in which additional or fewer constituent data entities result from the balancing, additional data points for constituent data entities #5-8 may be populated and/or one or more of constituent data entities #1-4 may be reduced to zero in the predicted data set. Similar outputs may be used for any number of constituent data entity inputs.

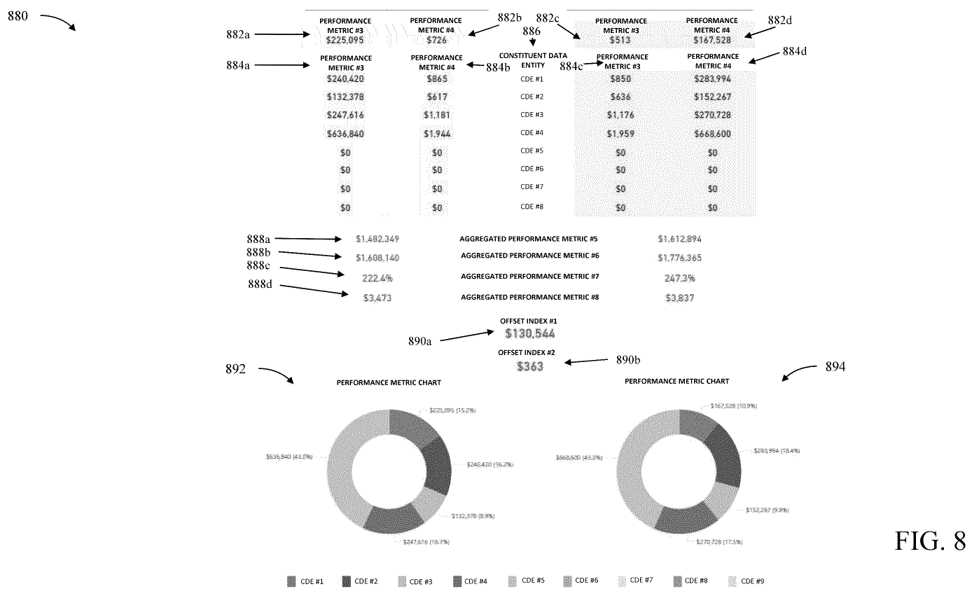

Referring now to FIG. 8, an example of a second portion of an offset index user display 880 is provided. The second portion of the display 880 may be provided below the first portion 770 shown in FIG. 7 on the same interface (e.g., a scrollable web interface) or on a separate interface. As depicted in FIG. 8, following analysis by the framework, the example offset index user display 880 displays various actual target entity performance metrics 882a-b, 884a-b corresponding to the actual current state of the target entity for comparison with various predicted opportunity performance metrics 882c-d, 884c-d after optimization that are generated via the various framework processes described herein. In the depicted embodiment, the display 880 includes global performance metrics 882a-d (e.g., reserve income 882a, 882d and income per transaction 882b, 882c) as well as the performance metrics 884a-d for each of the corresponding constituent data entities 886. The constituent data entities 886 may be the same as the constituent data entities 776 of FIG. 7 while the performance metrics 882a-d, 884a-d may be different and/or the performance metrics may be the same while the constituent data entities may be different. While the final four constituent data entities are zero for both the actual and predicted data sets, in some embodiments in which additional or fewer constituent data entities result from the balancing, additional data points for constituent data entities #5-8 may be populated and/or one or more of constituent data entities #1-4 may be reduced to zero in the predicted data set. Similar outputs may be used for any number of constituent data entity inputs. Such an offset index user display 880 enables analysis based on a specific constituent data entity. FIG. 8 further depicts a section showing aggregate performance metrics 888a-d which may include one or more totals or combined performance metrics (e.g., gross F&I income 888a, gross F&I income+over remit 888b, product penetration 888c, and PVR 888d). The display 880 may further include example offset indexes 890a-b generated based on a comparison of the actual and predicted optimization data sets. At least a portion of the output of the framework may further configure the offset index to be executed and realized via computer program instructions to balance the target entity system based on the predicted optimization data sets.

As further depicted in FIG. 8, the example offset index user display 880 includes a target entity performance metric chart 892 depicting the actual performance metrics of the target entity, broken down based on particular constituent data entities (e.g., CDE #1, CDE #2, CDE #3, etc.). In addition, the example offset index user display 880 includes a subject entity performance metric chart 894 depicting the predicted performance metrics of the target entity broken down based on particular constituent data entities (e.g., CDE #1, CDE #2, CDE #3, etc.).

Each of the portions of the example offset index user display may be updated in real-time based on user input manually updating target entity performance metrics or predicted target entity performance metrics. Further, various sources of data may be continuously or periodically updated, for example, performance metrics, characteristics, and constituent data entities associated with the set of subject entities may be continuously or periodically updated, resulting in updates to the offset index user display 880. Such real-time feedback facilitates the rapid, automated analysis and rapid on-the-fly reconfiguration of a target entity because of a unique data framework. In addition, the offset index 890a-b utilized to update the target constituent data entity set of the target entity may be tuned to provide immediate improvements to optimize the target entity without experimentation or testing based on the predictions generated by the framework as discussed herein. In some embodiments, at least reduced experimentation or testing may be facilitated by the framework discussed herein.

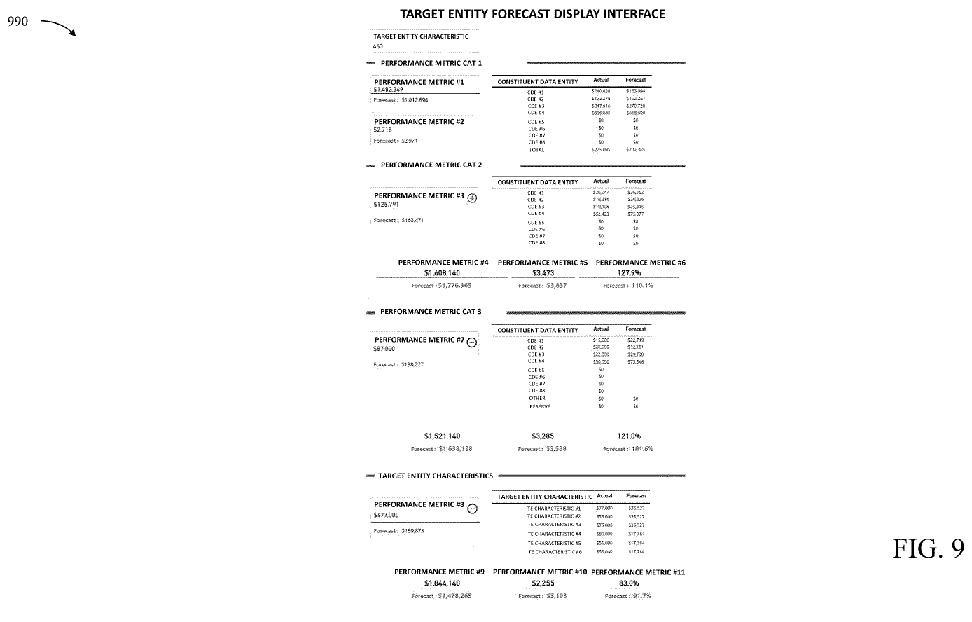

Referring now to FIG. 9, an example target entity forecast display interface 990 is provided. As depicted in FIG. 9, the example target entity forecast display interface 990 provides a side-by-side comparison of actual performance metrics of a target entity and forecast performance metrics of the target entity, such as those derived from the dynamic aggregated performance metric set and/or included in the forecast input illustrated in FIG. 6. As depicted in FIG. 9, the comparison of actual performance metrics of the target entity and forecast performance metrics of the target entity may be broken down by performance metric categories and further broken down by particular constituent data entities (e.g., CDE #1, CDE #2, CDE #3, etc.).

Each of the outputs displayed by the of the example target entity forecast display interface 990 may be updated in real-time based on user input manually updating target entity performance metrics or predicted target entity performance metrics. Further, various sources of data may be continuously or periodically updated, for example, performance metrics, characteristics, and constituent data entities associated with the set of subject entities (e.g., to continuously update forecasts in some embodiments) may be continuously or periodically updated, resulting in updates to the target entity forecast display interface 990. Such real-time feedback facilitates the rapid, automated analysis and rapid on-the-fly reconfiguration of a target entity because of a unique data framework. In addition, the offset index utilized to update the target constituent data entity set of the target entity may be perfectly tuned to provide immediate improvements without experimentation or testing.

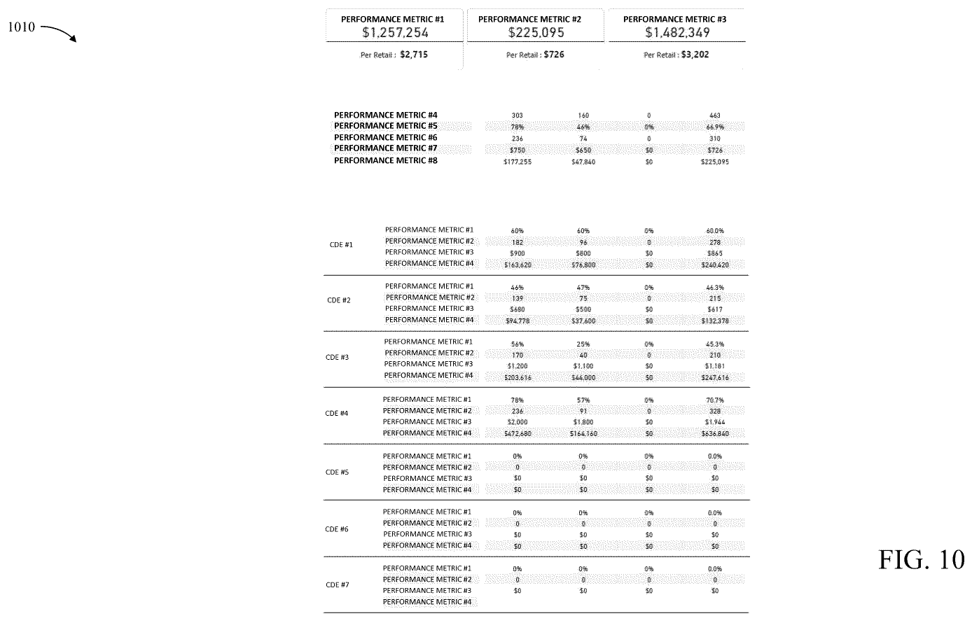

Referring now to FIG. 10, an example target entity forecast display interface 1010 is provided. As depicted in FIG. 10, the example target entity forecast display interface 1010 provides a side-by-side comparison of performance metrics between actual performance metrics of the target entity and forecast performance metrics of the target entity broken down according to particular constituent data entities (e.g., CDE #1, CDE #2, CDE #3, etc.).

Each of the outputs displayed by the of the example target entity forecast display interface 1010 may be updated in real-time based on user input manually updating target entity performance metrics or predicted target entity performance metrics. Further, various sources of data may be continuously or periodically updated, for example, performance metrics, characteristics, and constituent data entities associated with the set of subject entities may be continuously or periodically updated, resulting in updates to the target entity forecast display interface 1010. Such real-time feedback facilitates the rapid, automated analysis and rapid on-the-fly reconfiguration of a target entity because of a unique data framework. In addition, the offset index utilized to update the target constituent data entity set of the target entity may be perfectly tuned to provide immediate improvements without experimentation or testing.

In reference to FIG. 6-FIG. 10, for simplicity, percentages, absolute values, relative values, dollars, and the like are displayed for some performance metrics. However, as described herein, any metric may be used to quantify performance of the target entity, subject entities, and/or forecast models.

Referring now to FIG. 11, an example apparatus 1100 configured to perform one or more functions according to the present disclosure. For example, the central constituent entity control system 118, one or more subject entity systems 105a-n, and/or one or more target entity systems 107 may comprise one or more apparatuses 1100 configured to perform the respective functions associated therewith. For example, the apparatus 1100 may be configured to execute at least a portion of the target entity optimization model framework 102 in accordance with at least some example embodiments of the present disclosure. The depicted apparatus 1100 includes processor 1102, input/output circuitry 1104, data storage media 1106, and communications circuitry 1108. In some embodiments, the depicted apparatus 1100 is configured, using one or more of the sets of circuitry 1102, 1104, 1106, and/or 1108, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the depicted apparatus 1100 provide or supplement the functionality of other particular sets of circuitry. For example, the processor 1102 in some embodiments provides processing functionality to any of the sets of circuitry, the data storage media 1106 provides storage functionality to any of the sets of circuitry, the communications circuitry 1108 provides network interface functionality to any of the sets of circuitry, and/or the like.

In some embodiments, the processor 1102 (and/or co-processor or any other processing circuitry assisting or otherwise associated with the processor) is/are in communication with the data storage media 1106 via a bus for passing information among components of the depicted apparatus 1100. In some embodiments, for example, the data storage media 1106 is non-transitory and may include, for example, one or more volatile and/or non-volatile memories. In other words, for example, the data storage media 1106 in some embodiments includes or embodies an electronic storage device (e.g., a computer readable storage medium). In some embodiments, the data storage media 1106 is configured to store information, data, content, applications, instructions, or the like, for enabling the depicted apparatus 1100 to carry out various functions in accordance with example embodiments of the present disclosure.

The processor 1102 may be embodied in a number of different ways. For example, in some example embodiments, the processor 1102 includes one or more processing devices configured to perform independently. Additionally, or alternatively, in some embodiments, the processor 1102 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the depicted apparatus 1100, and/or one or more remote or “cloud” processor(s) external to the depicted apparatus 1100.

In an example embodiment, the processor 1102 is configured to execute instructions stored in the data storage media 1106 or otherwise accessible to the processor. Alternatively, or additionally, the processor 1102 in some embodiments is configured to execute hard-coded functionality. As such, whether configured by hardware or software methods, or by a combination thereof, the processor 1102 represents an entity (e.g., physically embodied in circuitry) capable of performing operations according to an embodiment of the present disclosure while configured accordingly. Alternatively, or additionally, as another example in some example embodiments, when the processor 1102 is embodied as an executor of software instructions, the instructions specifically configure the processor 1102 to perform the algorithms embodied in the specific operations described herein when such instructions are executed.

In some embodiments, the depicted apparatus 1100 includes input/output circuitry 1104 that provides output to the user and, in some embodiments, to receive an indication of a user input. In some embodiments, the input/output circuitry 1104 is in communication with the processor 1102 to provide such functionality. The input/output circuitry 1104 may comprise one or more user interface(s) (e.g., user interface) and in some embodiments includes a display that comprises the interface(s) rendered as a web user interface, an application user interface, a user device, a backend system, or the like. The processor 1102 and/or input/output circuitry 1104 comprising the processor may be configured to control one or more functions of one or more user interface elements through computer program instructions (e.g., software and/or firmware) stored on a memory accessible to the processor (e.g., data storage media 1106, and/or the like). In some embodiments, the input/output circuitry 1104 includes or utilizes a user-facing application to provide input/output functionality to a client device and/or other display associated with a user.

In some embodiments, the depicted apparatus 1100 includes communications circuitry 1108. The communications circuitry 1108 includes any means such as a device or circuitry embodied in either hardware or a combination of hardware and software that is configured to receive and/or transmit data from/to a network and/or any other device, circuitry, or module in communication with the depicted apparatus 1100. In this regard, the communications circuitry 1108 includes, for example in some embodiments, a network interface for enabling communications with a wired or wireless communications network. Additionally, or alternatively in some embodiments, the communications circuitry 1108 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 1108 includes circuitry for interacting with the antenna(s) and/or other hardware or software to cause transmission of signals via the antenna(s) or to handle receipt of signals received via the antenna(s). In some embodiments, the communications circuitry 1108 enables transmission to and/or receipt of data from a client device in communication with the depicted apparatus 1100.

Additionally, or alternatively, in some embodiments, one or more of the sets of circuitry 1102-1108 are combinable. Additionally, or alternatively, in some embodiments, one or more of the sets of circuitry perform some or all of the functionality described associated with another component. For example, in some embodiments, one or more sets of circuitry 1102-1108 are combined into a single module embodied in hardware, software, firmware, and/or a combination thereof. Similarly, in some embodiments, one or more of the sets of circuitry is/are combined such that the processor 1102 performs one or more of the operations described above with respect to each of these circuitry individually.

While this detailed description has set forth some embodiments of the present invention, the appended claims cover other embodiments of the present invention which differ from the described embodiments according to various modifications and improvements. For example, one skilled in the art may recognize that such principles may be applied to any target entity comprising one more variables associated with add-on packages, supplemental products, product pricing, inventory, costs, and so on. For example, automobile dealerships, boat dealerships, recreational vehicle dealerships, jewelry stores, electronics dealers, mobile device dealers, instrument dealers, equipment rental dealers, insurance companies, and so on.

Within the appended claims, unless the specific term “means for” or “step for” is used within a given claim, it is not intended that the claim be interpreted under 35 U.S.C. 112, paragraph 6. Use of broader terms such as “comprises,” “includes,” and “having” should be understood to provide support for narrower terms such as “consisting of,” “consisting essentially of,” and “comprised substantially of”. Use of the terms “optionally,” “may,” “might,” “possibly,” “can”, and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A system comprising:
a set of subject entity systems, each subject entity system comprising:
a subject entity constituent data entity set comprising a subject entity subset of a plurality of constituent data entities; and
one or more subject entity performance metrics associated with the subject entity;
a target entity system comprising:
an initial target constituent data entity set comprising a target entity subset of the plurality of constituent data entities; and
one or more target entity performance metrics associated with the target entity; and
at least one non-transitory computer readable medium comprising computer program instructions that, when executed by at least one processor, are configured to execute a target entity optimization model framework by:
aggregating the one or more subject entity performance metrics associated with a subset of the set of subject entity systems to generate a dynamic aggregated performance metric set;
retrieving the one or more target entity performance metrics associated with the target entity;
programmatically generating an offset index for the target entity system based on a comparison of the dynamic aggregated performance metric set and the one or more target entity performance metrics associated with the target entity; and
based on the offset index, triggering a balancing of the initial target constituent data entity set associated with the target entity system to generate an updated target constituent data entity set, the balancing comprising improving the target entity system by augmenting at least one constituent data entity of the target entity subset of the plurality of constituent data entities or adding at least one additional constituent data entity of the plurality of constituent data entities to the target entity subset of the plurality of constituent data entities.

2. The system of claim 1, wherein aggregating the one or more subject entity performance metrics comprises selecting the subset of the set of subject entity systems based on geolocation data associated with the subset of subject entities.

3. The system of claim 2, wherein the geolocation data comprises location data values associated with the set of subject entity systems and a target location data value associated with the target entity, wherein the computer program instructions, when executed by the at least one processor, are further configured to:
compare distances between the location data values associated with at least the subset of the set of subject entity systems and the target location data value associated with the target entity with a maximum threshold distance; and
select the subset of the set of subject data entity systems based on determining that the distances are less than the maximum threshold distance.

4. The system of claim 2, wherein the geolocation data comprises a geolocation characteristic associated with the set of subject entity systems and a target geolocation characteristic associated with the target entity, wherein the computer program instructions, when executed by the at least one processor, are further configured to:
compare the geolocation characteristic associated with at least the subset of the set of subject data entity systems and the target geolocation characteristic associated with the target entity with a geolocation characteristic range; and
select the subset of the set of subject entity systems based on determining that the geolocation characteristics are within the geolocation characteristic range.

5. The system of claim 1, wherein in aggregating the one or more subject entity performance metrics, the computer program instructions, when executed by the at least one processor, are further configured to:
compare a difference in a size of the subject entity constituent data entity set associated with at least the subset of the set of subject entity systems and a size of the initial target constituent data entity set associated with a maximum difference threshold; and select the subset of the set of subject data entity systems based on determining that the difference is less than a the maximum difference threshold.

6. The system of claim 1, wherein in aggregating the one or more subject entity performance metrics, the computer program instructions, when executed by the at least one processor, are further configured to:
select one or more reference constituent data entities in the initial target constituent data entity set; and
select a subject data entity for inclusion in the subset of the set of subject data entity systems based on determining that the subject data entity comprises the one or more reference constituent data entities in the subject entity constituent data entity set.

7. The system of claim 1, wherein in generating the dynamic aggregated performance metric set, the computer program instructions, when executed by the at least one processor, are further configured to:
receive one or more updated performance metrics via user inputs to a graphical user interface;
determine a second subset of the set of subject entity systems based on the updated performance metrics;
aggregate the one or more subject entity performance metrics associated with the second subset of the set of subject entity systems to update the dynamic aggregated performance metric set; and
programmatically generate an updated offset index for the target entity system based on a comparison of the dynamic aggregated performance metric set and the one or more target entity performance metrics associated with the target entity.

8. The system of claim 1, wherein in an instance in which the one or more target entity performance metrics are updated via user inputs to a graphical user interface, the computer program instructions, when executed by the at least one processor, are further configured to:
programmatically regenerate the offset index based on a comparison of the dynamic aggregated performance metric set and the one or more target entity performance metrics associated with the target entity.

9. The system of claim 1, wherein the computer program instructions, when executed by the at least one processor, are further configured to:
generate updated subject entity performance metrics based on the updated target constituent data entity set;
compare the updated subject entity performance metrics with the one or more subject entity performance metrics associated with the initial target constituent data entity set; and
confirm the updated subject entity performance metrics represent an improvement over the one or more subject entity performance metrics associated with the initial target constituent data entity set.

10. A computer-implemented method comprising:
determining, by a target entity optimization model framework, a subset of a set of subject entity systems, each subject entity system comprising:
a subject entity constituent data entity set comprising a subject entity subset of a plurality of constituent data entities; and
one or more subject entity performance metrics associated with the subject entity;
aggregating the one or more subject entity performance metrics associated with the subset of the set of subject entity systems to generate a dynamic aggregated performance metric set;
retrieving from a target entity system one or more target entity performance metrics associated with a target entity, the target entity system comprising:
an initial target constituent data entity set comprising a target entity subset of the plurality of constituent data entities; and
the one or more target entity performance metrics associated with the target entity;
programmatically generating an offset index for the target entity system based on a comparison of the dynamic aggregated performance metric set and the one or more target entity performance metrics associated with the target entity; and
based on the offset index, triggering a balancing of the initial target constituent data entity set associated with the target entity system to generate an updated target constituent data entity set, the balancing comprising improving the target entity system by augmenting at least one constituent data entity of the target entity subset of the plurality of constituent data entities or adding at least one additional constituent data entity of the plurality of constituent data entities to the target entity subset of the plurality of constituent data entities.

11. The computer-implemented method of claim 10, wherein aggregating the one or more subject entity performance metrics comprises selecting the subset of the set of subject entity systems based on geolocation data associated with the subset of the set of subject entity systems.

12. The computer-implemented method of claim 11, wherein the geolocation data comprises location data values associated with the set of subject entities and a target location data value associated with the target entity, wherein the computer-implemented method further comprises:
comparing distances between the location data values associated with at least the subset of the set of subject data entities and the target location data value associated with the target entity with a maximum threshold distance; and
selecting the subset of the set of subject entity systems based on determining that the distances are less than the maximum threshold distance.

13. The computer-implemented method of claim 11, wherein the geolocation data comprises a geolocation characteristic associated with the set of subject entities and a target geolocation characteristic associated with the target entity, wherein the computer-implemented method further comprises:
comparing the geolocation characteristic associated with at least the subset of the set of subject entity systems and the target geolocation characteristic associated with the target entity with a geolocation characteristic range; and
selecting the subset of the set of subject entity systems based on determining that the geolocation characteristics are within the geolocation characteristic range.

14. The computer-implemented method of claim 10, wherein in aggregating the one or more subject entity performance metrics, the computer-implemented method further comprises:
comparing a difference in a size of the subject entity constituent data entity set associated with at least the subset of the set of subject entity systems and a size of the initial target constituent data entity set associated with a maximum difference threshold; and
selecting the subset of the set of subject entity systems based on determining that the difference is less than the maximum difference threshold.

15. The computer-implemented method of claim 10, wherein in aggregating the one or more subject entity performance metrics, the computer-implemented method further comprises:
selecting one or more reference constituent data entities in the initial target constituent data entity set; and
selecting a subject data entity for inclusion in the subset of the set of subject entity systems based on determining that the subject data entity comprises the one or more reference constituent data entities in the subject entity constituent data entity set.

16. The computer-implemented method of claim 10, wherein in generating the dynamic aggregated performance metric set, the computer-implemented method further comprises:
updating the dynamic aggregated performance metric set with a second plurality of performance metrics associated with a second subset of the set of subject entity systems; and
programmatically regenerating the offset index based on a comparison of the dynamic aggregated performance metric set and the one or more target entity performance metrics associated with the target entity.

17. The computer-implemented method of claim 16, wherein in generating the dynamic aggregated performance metric set, the computer-implemented method further comprises:
receiving one or more updated performance metrics via user inputs to a graphical user interface;
determining the second subset of the set of subject entity systems based on the updated performance metrics;
aggregating the one or more subject entity performance metrics associated with the second subset of the set of subject entity systems to update the dynamic aggregated performance metric set; and
programmatically generating an updated offset index for the target entity system based on a comparison of the dynamic aggregated performance metric set and the one or more target entity performance metrics associated with the target entity.

18. The computer-implemented method of claim 10, wherein in an instance in which the one or more target entity performance metrics are updated via user inputs to a graphical user interface, the computer-implemented method further comprises:
programmatically regenerating the offset index based on a comparison of the dynamic aggregated performance metric set and the one or more target entity performance metrics associated with the target entity.

19. The computer-implemented method of claim 10, wherein the computer-implemented method further comprises:
generating updated subject entity performance metrics based on the updated target constituent data entity set;
comparing the updated subject entity performance metrics with the one or more subject entity performance metrics associated with the initial target constituent data entity set; and
confirming the updated subject entity performance metrics represent an improvement over the one or more subject entity performance metrics associated with the initial target constituent data entity set.

20. A computer program product, stored on at least one computer readable medium, comprising instructions that when executed by one or more computers cause the one or more computers to:
determine, by a target entity optimization model framework, a subset of a set of subject entity systems, each subject entity system comprising:
a subject entity constituent data entity set comprising a subject entity subset of a plurality of constituent data entities; and
one or more subject entity performance metrics associated with the subject entity;
aggregate the one or more subject entity performance metrics associated with the subset of the set of subject entity systems to generate a dynamic aggregated performance metric set;
retrieve from a target entity system one or more target entity performance metrics associated with a target entity, the target entity system comprising:
an initial target constituent data entity set comprising a target entity subset of the plurality of constituent data entities; and
the one or more target entity performance metrics associated with the target entity;
programmatically generate an offset index for the target entity system based on a comparison of the dynamic aggregated performance metric set and the one or more target entity performance metrics associated with the target entity; and
based on the offset index, trigger a balancing of the initial target constituent data entity set associated with the target entity system to generate an updated target constituent data entity set, the balancing comprising improving the target entity system by augmenting at least one constituent data entity of the target entity subset of the plurality of constituent data entities or adding at least one additional constituent data entity of the plurality of constituent data entities to the target entity subset of the plurality of constituent data entities.
